(19) United States
(12) Patent Application Publication
(10) Pub. No.: US 2025/0148855 A1
(43) Pub. Date: May 8, 2025

(54) VISION SYSTEM WITH RECTILINEAR MOTION FOR SMART UNATTENDED RETAIL DEVICE

(71) Applicant: Crane Payment Innovations, Inc., Malvern, PA (US)

(72) Inventors: Viralsinh H. Chhasatia, Paoli, PA (US); Douglas William Drenten, Lexington, SC (US); Dmytro Baydin, Glenmoore, PA (US)

(21) Appl. No.: 18/727,657

(22) PCT Filed: Jan. 12, 2023
(86) PCT No.: PCT/US2023/060585

§ 371 Date: Jul. 9, 2024

Related U.S. Application Data
(60) Provisional application No. 63/303,916, filed on Jan. 27, 2022.

(51) Int. Cl. G07F 9/00; G06Q 20/18; G06V 20/40; G07F 11/60

(52) U.S. Cl. CPC G07F 9/006; G06Q 20/18; G06V 20/44; G07F 9/009; G07F 11/60

(57) ABSTRACT

An unattended retail device includes a cabinet for storing items, a door configured to open or close an area inside the cabinet, and a vision system positioned within an interior space of the door. The vision system includes a movement system coupled to the door, a housing moveably mounted to the movement system, the housing including an imaging sensor configured to capture images or video frames, and at least one processor operably coupled to the imaging sensor and the movement system. The at least one processor is configured to control the movement system to move the housing within the interior space of the door, receive one or more images or video frames captured by the imaging sensor at one or more locations within the interior space of the door, and instruct an action based on the one or more images or video frames.

### CROSS-REFERENCE TO RELATED APPLICATIONS

This application is a 371 National Stage of International Application No. PCT/US2023/060585, filed Jan. 12, 2023, which claims priority to U.S. Provisional Patent Application No. 63/303,916, filed Jan. 27, 2022, the disclosures of which are incorporated herein by reference in their entirety.

### TECHNICAL FIELD

This disclosure relates generally to unattended retail devices. More specifically, this disclosure relates to a vision system with rectilinear motion for a smart unattended retail device.

### BACKGROUND

In an unattended retail application, several attributes are essential to providing a satisfying consumer experience. First, a consumer must be attracted to the merchandise or products and access must be convenient. This requires merchandise or products to be highly visible in a clean and organized fashion, which is typically accomplished by displaying and organizing products on shelving with good lighting. Second, desired and popular products must be available for purchase. And third, a consumer must be able to shop in a fashion that is comfortable, similar to that encountered in a normal retail setting, and that provides ease of access to products and simplicity in completing a transaction. In addition, in an unattended retail application, the operator has limited control over the machine because a consumer has access to the products in the machine. Consumers can therefore rearrange products in the machine, leading to reduced organization of the products within the machine.

### SUMMARY

This disclosure provides a vision system with rectilinear motion for a smart unattended retail device.

In one embodiment, an unattended retail device includes a cabinet for storing items. The unattended retail device also includes a door configured to open or close an area inside the cabinet. The unattended retail device also includes a vision system positioned within an interior space of the door. The vision system includes a movement system coupled to the door. The vision system also includes a housing moveably mounted to the movement system, the housing including an imaging sensor configured to capture images or video frames. The vision system also includes at least one processor operably coupled to the imaging sensor and the movement system. The at least one processor is configured to control the movement system to move the housing within the interior space of the door. The at least one processor is also configured to receive one or more images or video frames captured by the imaging sensor at one or more locations within the interior space of the door. The at least one processor is also configured to instruct an action based on the one or more images or video frames.

In another embodiment, a method includes controlling, using at least one processor, a movement system to move a housing including an imaging sensor within an interior space of a door of an unattended retail device. The unattended retail device includes a cabinet for storing items, wherein the door opens or closes an area inside the cabinet. The unattended retail device also includes a vision system positioned within the interior space of the door, wherein the vision system includes the movement system and the housing. The method also includes receiving, using the at least one processor, one or more images or video frames captured by the imaging sensor at one or more locations within the interior space of the door. The method also includes instructing, using the at least one processor, an action based on the one or more images or video frames.

In another embodiment, a smart unattended retail device includes a cabinet, an auditing camera system, a door, one or more external displays, and a vision system. The cabinet is configured to store items. The auditing camera system is mounted in the cabinet and configured to determine items placed in or removed from the cabinet. The door is configured to open or close an area inside the cabinet and to lock or unlock the cabinet, where the door comprises at least two panes defining an interior space. The one or more external displays are configured to display information. The vision system is positioned within the interior space of the door and includes a camera housing, an X-Y mechanism, and at least one processor. The camera housing includes a camera sensor configured to capture image or video frames. The X-Y mechanism is coupled to the door and the camera housing and is configured to move the camera housing within the space of the door. The processor is operably coupled to the camera housing and the X-Y mechanism. The at least one processor is configured to control the X-Y mechanism to move the camera housing within the space to capture items inserted or removed from the cabinet. The at least one processor is also configured to control the X-Y mechanism to move the camera housing to a default location after capturing the items inserted or removed from the cabinet. The at least one processor is further configured to control the camera housing to rotate the camera sensor towards an inside of the cabinet for capturing the items inserted or removed from the cabinet. The at least one processor is additionally configured to control the camera housing to rotate the camera sensor toward an outside of the cabinet for identifying a customer when at the default location.

In another embodiment, a smart unattended retail device includes a cabinet, an auditing camera system, a door, one or more external displays, and a vision system. The cabinet is configured to store items and includes rotating shelves. The auditing camera system is mounted in the cabinet and configured to determine items placed in or removed from the cabinet. The door is configured to open or close an area inside the cabinet and to lock or unlock the cabinet, where the door comprises at least two panes defining an interior space. The one or more external displays are configured to display information. The vision system is positioned within the interior space of the door and includes a camera housing, a linear mechanism, and at least one processor. The camera housing includes a camera sensor configured to capture image or video frames. The linear mechanism is coupled to the door and the camera housing and is configured to move the camera housing within the space of the door. The processor is operably coupled to the camera housing and the linear mechanism. The at least one processor is configured to control the linear mechanism to move the camera housing within the space to capture items inserted or removed from the cabinet, where the rotating shelf is rotated to capture the items inserted or removed from the cabinet. The at least one processor is also configured to control the linear mechanism to move the camera housing to a default location after capturing the items inserted or removed from the cabinet. The at least one processor is further configured to control the camera housing to rotate the camera sensor towards an inside of the cabinet for capturing the items inserted or removed from the cabinet. The at least one processor is additionally configured to control the camera housing to rotate the camera sensor toward an outside of the cabinet for identifying a customer when at the default location.

In another embodiment, a smart unattended retail device includes a cabinet, an auditing camera system, a door, one or more external displays, and a vision system. The cabinet is configured to store items. The auditing camera system is mounted in the cabinet and configured to determine items placed in or removed from the cabinet. The door is configured to open or close an area inside the cabinet and to lock or unlock the cabinet, where the door comprises at least two panes defining an interior space. The one or more external displays are configured to display information. The vision system is positioned within the interior space of the door and includes one or more camera housings. The one or more camera housings each include a rotating device, a camera sensor, and at least one processor. The rotating device rotation device is configured to move a camera housing by rotating against one or the two panes of the door. The camera sensor is configured to capture image or video frames. The processor is operably coupled to the camera housing and the rotation device. The at least one processor is configured to control the rotation device to move the camera housing within the space to capture items inserted or removed from the cabinet. The at least one processor is also configured to control the rotating device to move the camera housing to a default location after capturing the items inserted or removed from the cabinet. The at least one processor is further configured to control the camera housing to rotate the camera sensor towards an inside of the cabinet for capturing the items inserted or removed from the cabinet. The at least one processor is additionally configured to control the camera housing to rotate the camera sensor toward an outside of the cabinet for identifying a customer when at the default location.

In another embodiment, a smart unattended retail device includes a cabinet, a door, a vision system, and at least one processor. The cabinet is configured to store items. The door is configured to open or close an area inside the cabinet. The vision system is positioned within the interior space of the door. The vision system includes a camera housing and a mechanism. The camera housing including a camera sensor configured to capture image or video frames. The mechanism is configured to move the camera housing within the space of the door. The at least one processor is operably coupled to the camera housing the mechanism. The at least one processor is configured to control the mechanism to move the camera housing within the space to capture items inserted or removed from the cabinet. The at least one processor is also configured to control the mechanism to move the camera housing to a default location after capturing the items inserted or removed from the cabinet.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication or interaction between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), electrically erasable programmable read only memory (EEPROM/E²PROM), random access memory (RAM), ferroelectric RAM (FRAM), a hard disk drive, a compact disc (CD), a digital video disc (DVD), or any other type of volatile/non-volatile/memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly-used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example unattended retail system in accordance with various embodiments of this disclosure;

FIG. 2 illustrates a simplified perspective view of a smart unattended retail device according to embodiments of the present disclosure;

FIGS. 3A-3X illustrate various views of an example smart unattended retail device including a vision system with rectilinear motion according to embodiments of the present disclosure;

FIGS. 4A and 4B illustrate an example smart unattended retail device including a vision system with rectilinear motion according to embodiments of the present disclosure;

FIGS. 5A and 5B illustrate an example door assembly including a vision system with rectilinear motion within a two pane door according to embodiments of the present disclosure;

FIGS. 6A and 6B illustrate an example door assembly including a vision system with rectilinear motion within a three pane door according to embodiments of the present disclosure;

FIG. 7A illustrates an example vision system with linear motion according to embodiments of the present disclosure;

FIG. 7B illustrates an example vision system with linear motion according to embodiments of the present disclosure;

FIG. 8 illustrates an example vision system with one or more rotation devices according to embodiments of the present disclosure;

FIG. 9 illustrates an example method for an unattended retail device in accordance with embodiments of this disclosure;

FIG. 10 illustrates an example electronic device in accordance with various embodiments of this disclosure; and

FIG. 11 illustrates an example electronic device in accordance with various embodiments of this disclosure.

### DETAILED DESCRIPTION

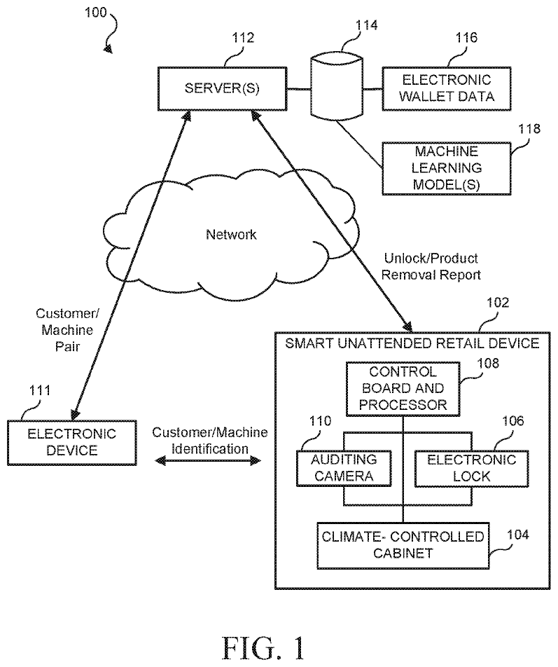

FIGS. 1 through 11, discussed below, and the various embodiments used to describe the principles of the present disclosure in this patent document are by way of illustration only and should not be construed in any way to limit the scope of the disclosure. Those skilled in the art will understand that the principles of this disclosure may be implemented in any suitably arranged device or system.

As used throughout this specification, the terms currency denomination, denomination of currency, valuable document, currency bill, bill, banknote, note, bank check, paper money, paper currency, coin, coinage, and cash may be used interchangeably herein to refer to a type of a negotiable instrument or any other writing that evidences a right to the payment of a monetary obligation, typically issued by a central banking authority.

In the unattended retail environment, a store must remain secure until the shopping event is initiated by the consumer, which is accomplished by the use of a locking door on the cabinet. In the shopping sequence, once the consumer establishes credit, the door can be unlocked providing access to the merchandise. When the door is unlocked, the consumer can shop, which allows for picking up products, examining products, and/or returning product to the same or different locations within the retail space. Once the door is closed, the shopping ends and the consumer is charged for any products removed from the cabinet.

Accounting for the removal and replenishment of inventory can be accomplished through the use of one or a combination of different technologies including: acoustic measurements, position measurements, displacement measurements, pressure measurements, force measurements, optical measurements, and others. Cameras may be permanently positioned in specific locations within a cabinet in a manner to allow the optimal range of vision to capture the removal and replacement of a product passing through a plane in the field of view at the face of the storage area. A deficiency of this method is that permanently positioned cameras are typically limited in a field of view and can only account for a front-most product or a limited depth for an amount of products on each shelf. The positioning of the cameras within the consumer accessible space also makes the cameras subject to vandalism or other attempts to defeat them.

Embodiments of this disclosure provide a vision system for an unattended retail device. The vision system can provide a secure merchandising display including a cabinet for storage and display of merchandise or products available for sale, a glass door that can be locked and unlocked when a credit is established through a payment system, and one or more camera housings that can detect removal and replacement of merchandise by the consumer or operator and also provide periodic feedback on the quantity, type, and condition of merchandise or other foreign objects within the cabinet. As non-limiting examples, unattended retail devices can include vending machines with a dispense mechanism, vending machines without a dispense mechanism, non-refrigerated vending machines, partially refrigerated vending machines, self-service machines, coolers, cabinets, etc.

This application focuses on the parts of an unattended retail process that ensure inventory in the storage area is monitored during the shopping process to correctly account for the transaction as it occurs; accounts for the inventory removed to allow for efficient replenishment by the retail operator; and monitors for theft or attempts to introduce foreign objects into the cabinet.

This application can utilize optical technologies including cameras and image recognition software to capture the specific stock keeping unit(s) being sold. In order to maintain a “frictionless” and satisfying shopping experience for the consumer, the optical system is able to recognize a wide range of shapes, sizes and geometries of the products. This vision system must also be able to recognize one or more products being taken, replaced and/or repositioned so that the customer is only charged for the products removed before ending the shopping experience by closing the door.

FIG. 1 illustrates an example unattended retail system 100 in accordance with various embodiments of this disclosure. In some embodiments, the system 100 includes a smart unattended retail device 102. In some embodiments, the unattended retail device 102 is a smart vending machine that is a cooler or refrigeration device, including a climate-controlled cabinet 104 that unlocks via an electronic lock 106, such as when a customer decides to make a purchase, allowing the customer to open a door of the cabinet 104 and retrieve one or more products. In some embodiments, product auditing and/or image recognition models 118 or algorithms are included in a memory of the unattended retail device 102, such as memory coupled to a control board and processor 108. In some embodiments, the product auditing and/or image recognition models or algorithms 118 are stored in a cloud server(s) 112, with the unattended retail device 102 providing images to a cloud server for processing and/or auditing using one or more imaging devices such as at least one auditing camera 110 disposed on or within the unattended retail device 102 and coupled to the control board and processor 108. The system 100 further includes the cloud server 112, which, in various embodiments, controls the locking/unlocking of the electronic lock 106 as well as receiving product removal reports from the unattended retail device 102, in addition to other functions. The unattended retail device 102 can communicate with the cloud server 112 via one or more network interfaces, and the unattended retail device 102 and cloud server 112 can be coupled via a wired or wireless network connection over a network such as a WAN or the Internet.

The system 100 also includes a customer mobile device 111 such as a smartphone or other device that communicates with the unattended retail device 102 in various ways, such as via a wireless connection such as a BLUETOOTH connection. In some embodiments, an operator can use a similar mobile device 111 to similarly communicate with the unattended retail device 102 to, for example, add new products to the unattended retail device 102 via a product addition and recognition process. The mobile device 111 can include a mobile application configured to communicate with both the unattended retail device 102 to establish customer and machine identifications, and with the cloud server 112 to provide the customer and machine identifications, as well as to facilitate payment for products.

Various funding sources can be used to facilitate payment by a customer for a product stored within the unattended retail device 102. For example, in various embodiments, the cloud server 112 stores, in a datastore 114, one or more of credit, debit, or ePayment information and a pre-authorization that is associated with a user. A pre-authorization for a transaction is made before the unattended retail device 102 is unlocked, and settlement is made once a product has been removed and the door is locked. In some embodiments, an electronic wallet 116 can be associated with each customer account and stored at, or in association with, the cloud server 112. The aforementioned credit, debit, or ePayment information can be used by a customer to manually add funds to the wallet, or the system 100 can be configured, such as in accordance with customer preferences or settings, to automatically add funds to the wallet, such as if the value of the products removed exceeds the amount stored in the wallet, or if the funds in the wallet falls below a threshold. In some embodiments, a third-party wallet-type system can be used, such as GOOGLE PAY, to fund a transaction from the mobile application on the mobile device, and a transaction success status is sent to the cloud server 112 to trigger unlocking of the cabinet 104 of the unattended retail device 102. In some embodiments, a paper coupon can be scanned by the mobile application to facilitate payment, or an electronic coupon can be stored in the cloud that can be redeemed for a product.

In various embodiments of this disclosure, the product auditing camera 110 can be one or more image capture devices such as a still image device or video camera device. In some embodiments, the image capture device is mounted or otherwise placed in a location in proximity to, or within, the unattended retail device 102 such that the image capture device 110 can capture images of the unattended retail device 102, particularly an internal portion of the cabinet 104, housing, or chassis where products are stored. In some embodiments, one or more image capture devices 110 can be placed within the internal compartment of the vending machine to capture images of the interior of the unattended retail device 102. In some embodiments, one or more image capture devices 110 can be installed on an exterior portion of the chassis of the vending machine, and positioned to view through a front window of the unattended retail device 102 into the internal compartment to capture images of the interior of the unattended retail device 102, as well as to view an external area of the vending machine during new product recognition and training processes. In some embodiments, one or more image capture devices 110 can be installed on an X-Y rail system, as described in the various embodiments of this disclosure. In some embodiments, an operator can use an image capture device 110, such as a handheld camera and/or a smartphone device, such as the electronic device 111, to capture images of products within the unattended retail device, or new products to be added to the unattended retail device system. In some embodiments, the system includes two or more image capture devices 110 that capture video of products moving in and/or out of the machine to maintain accurate product inventory information. In some embodiments, image capture devices 110 can be placed in areas where products on shelves are seen, such as through a window of the cabinet 104, or when cameras are placed inside the cabinet 104. In such embodiments, before and after images, that is, before a customer removes products and after a customer removes products, of products in the cabinet 104 can be captured.

Although FIG. 1 illustrates one example of a unattended retail system 100, various changes may be made to FIG. 1. For example, the unattended retail system 100 could include any suitable number of each component in any suitable arrangement. In general, unattended retail devices and computing and communication systems can come in a wide variety of configurations, and FIG. 1 does not limit the scope of this disclosure to any particular configuration. Also, while FIG. 1 illustrates one operational environment in which various features disclosed in this patent document can be used, these features could be used in any other suitable system.

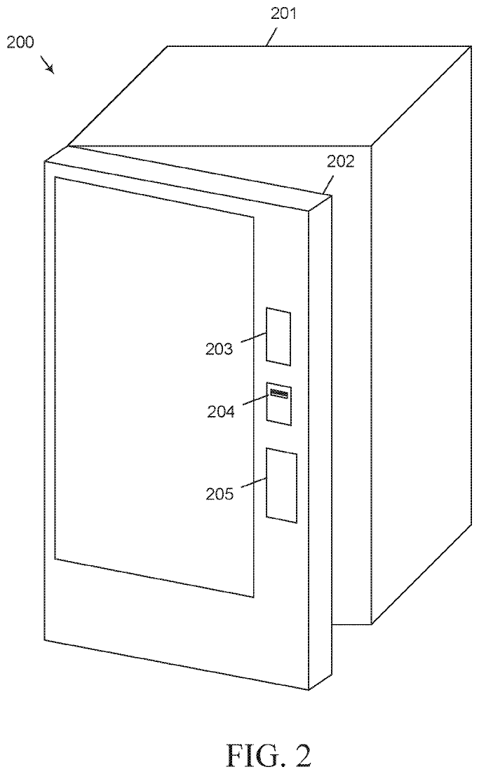

FIG. 2 illustrates a simplified perspective view of a smart unattended retail device 200 according to embodiments of the present disclosure. In various embodiments, the unattended retail device 200 can be an unattended retail device as described in various other embodiments of this disclosure, such as the unattended retail device 102 of FIG. 1.

The smart unattended retail device 200 includes a cabinet 201 and a service door 202 that, together, define an enclosure. In the embodiment illustrated in FIG. 2, the service door 202 is pivotally mounted to the front of the cabinet 201 and extends all the way across the front face of the unattended retail device 200. In alternate embodiments, the service door may extend only part way across the front of the unattended retail device, or may be formed in two portions (of equal or unequal sizes) that swing open in opposite directions. In alternate embodiments, the service door may slide open and allow a customer to access products.

In the embodiment illustrated in FIG. 2, the service door 202 includes a customer user interface 203, illustrated as a touch screen liquid crystal display (LCD) display. A payment system 204 is mounted within the service door 202 and includes one or more of a bill validator, a coin acceptor and/or a credit or debit card reader. The payment system 204 receives currency, coins or other forms of payment from the customer and returns change as necessary. The service door can also include a change dispensing area 205 for providing change in the form of coins and/or banknotes to the user.

The service door 202 may also include a vision system within an interior space of the door. The interior space of the door may be defined based on a space between two panes of the door. The interior space may be filled with argon to enhance the refrigeration of the inside of the cabinet. The vision system may also include an X-Y mechanism or platform for positioning a camera housing within the interior space for viewing products inside the cabinet and customers in front of the smart unattended retail device 200.

Although FIG. 2 illustrates one example of a smart unattended retail device 200, various changes may be made to FIG. 2. For example, in addition to the variations described above, various components in FIG. 2 may be combined, further subdivided, replicated, or rearranged according to particular needs. In general, unattended retail devices can come in a wide variety of configurations, and FIG. 2 does not limit the scope of this disclosure to any particular configuration of an unattended retail device. Also, while FIG. 2 illustrates one operational environment in which various features disclosed in this patent document can be used, these features could be used in any other suitable system.

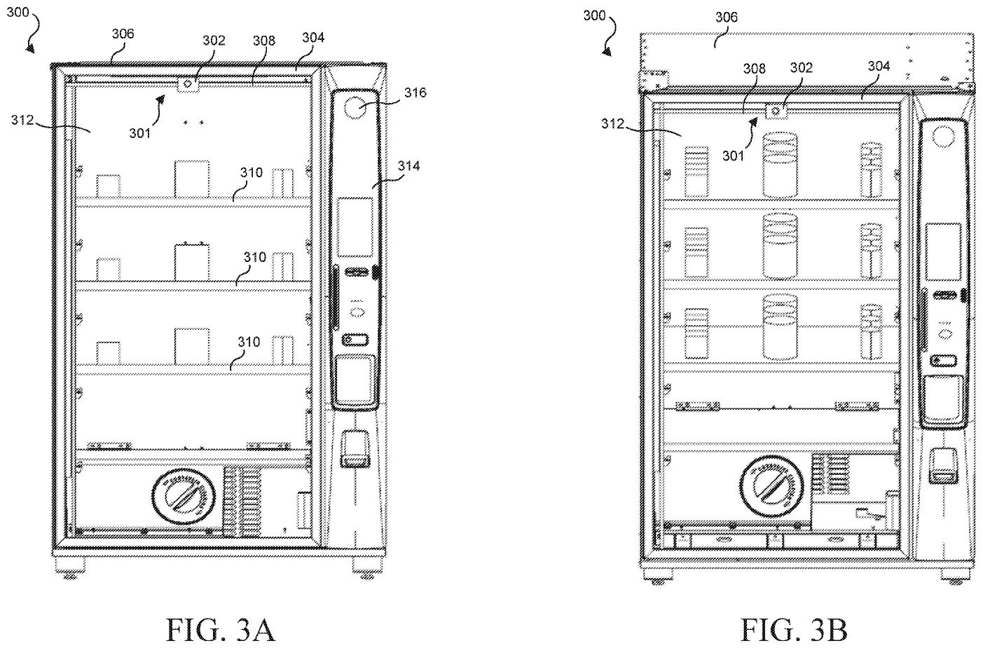

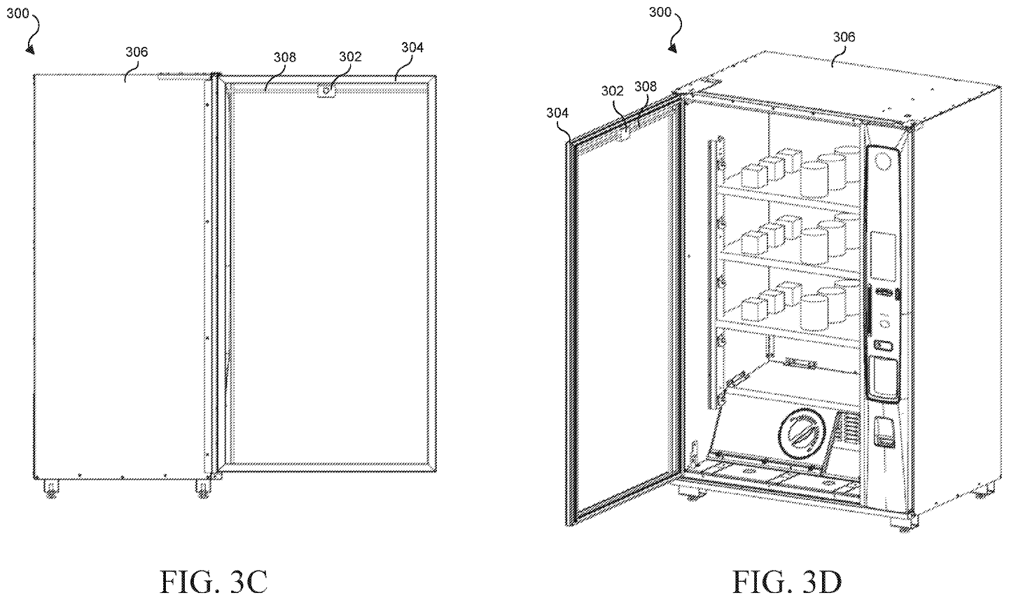

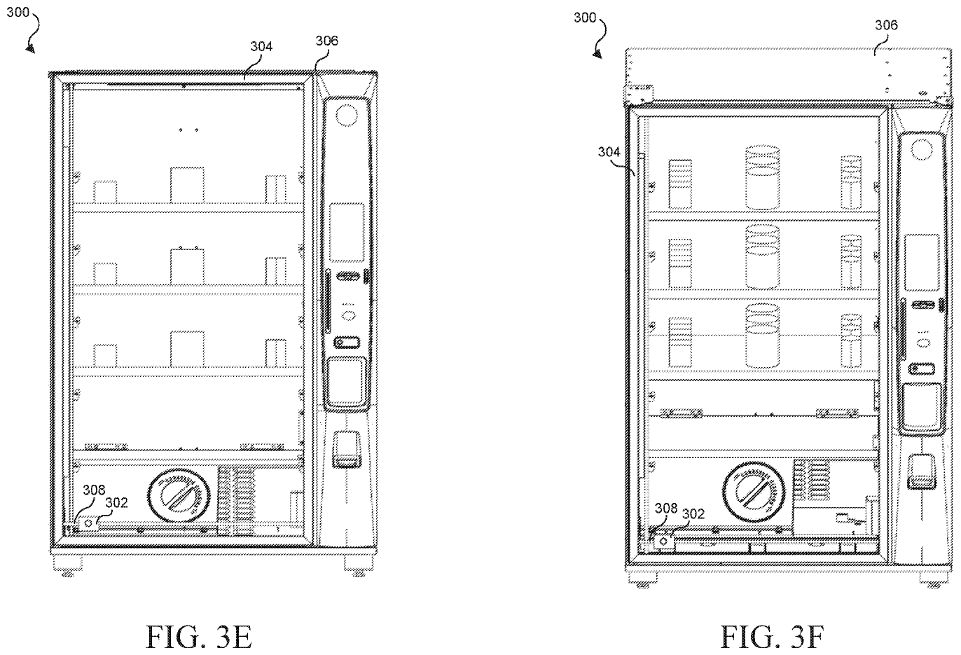

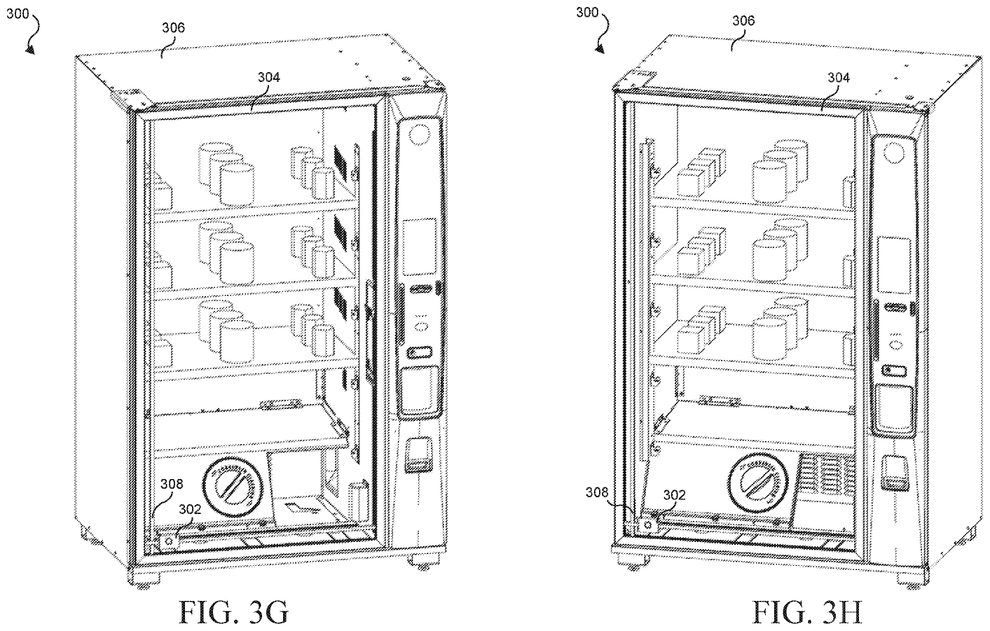

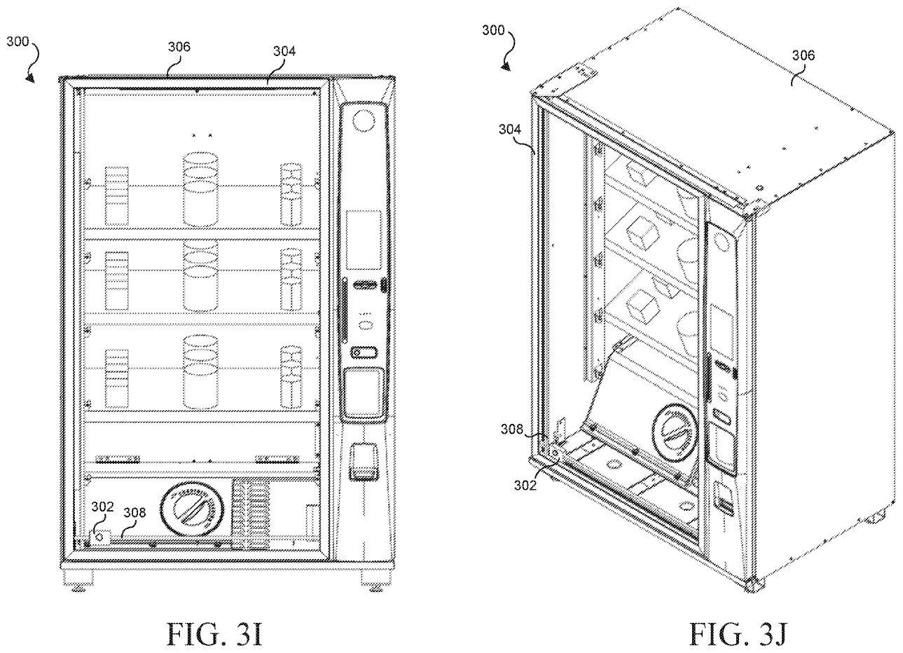

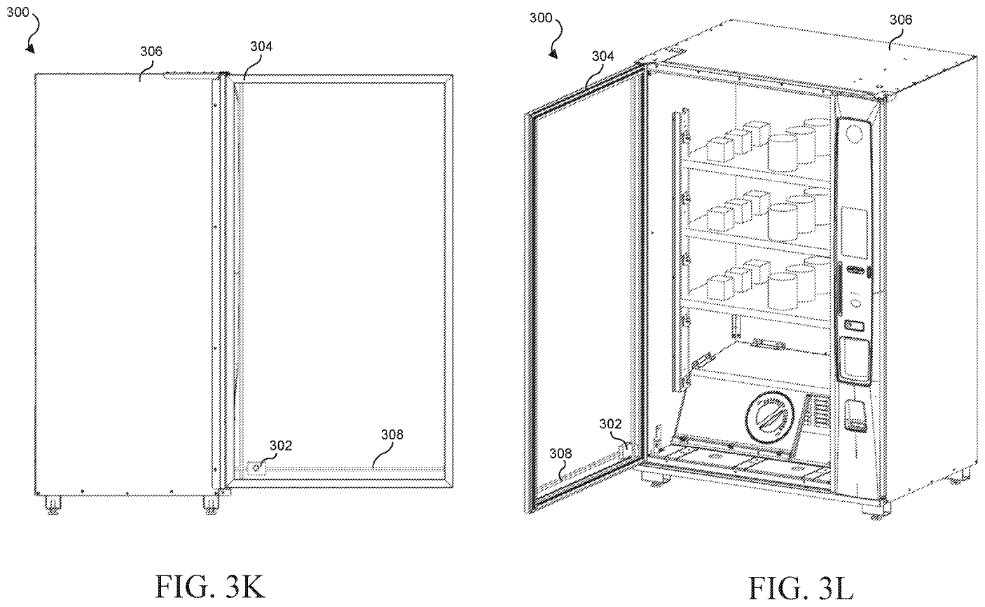

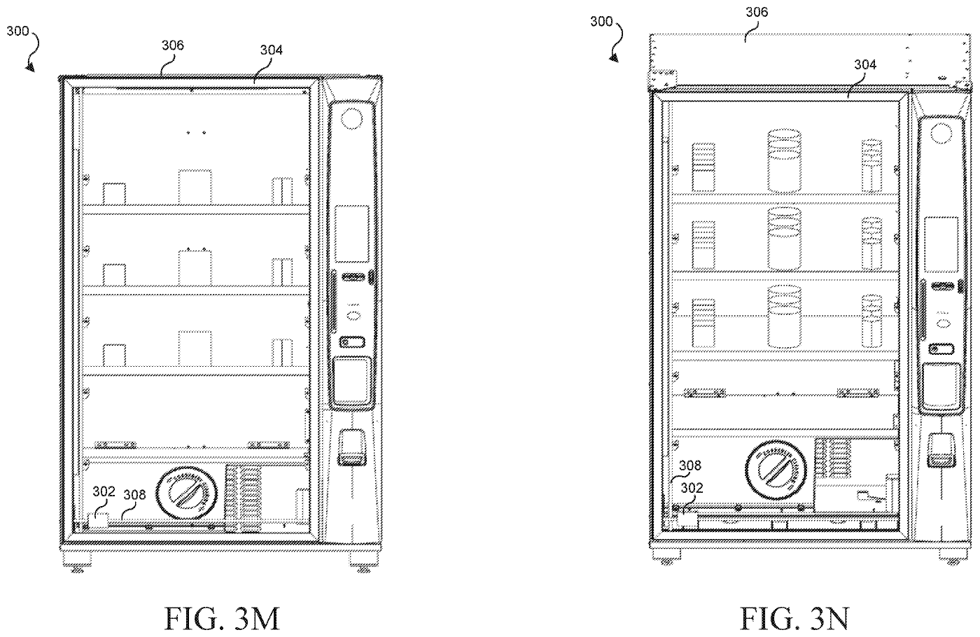

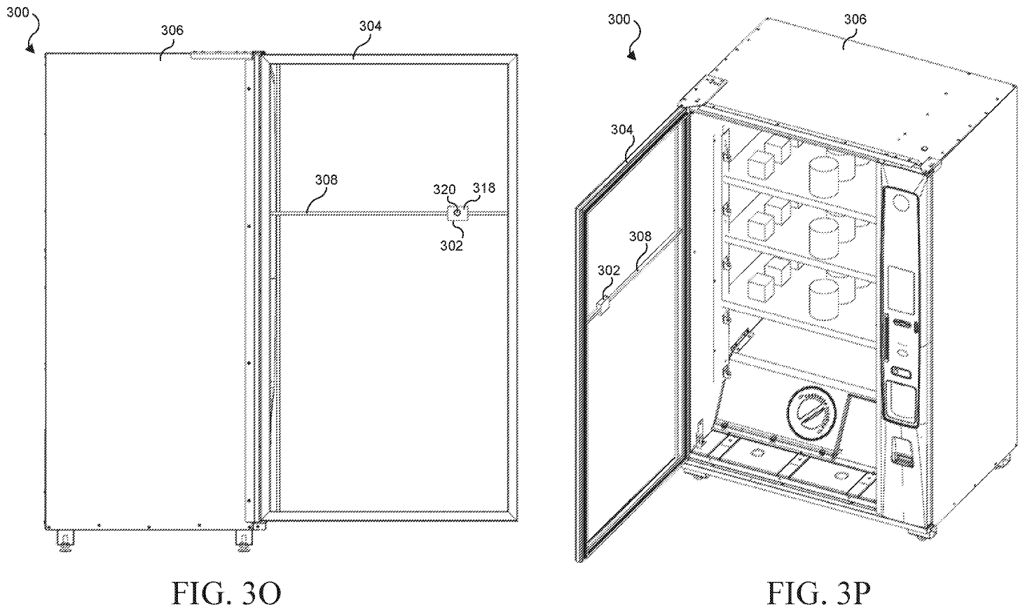

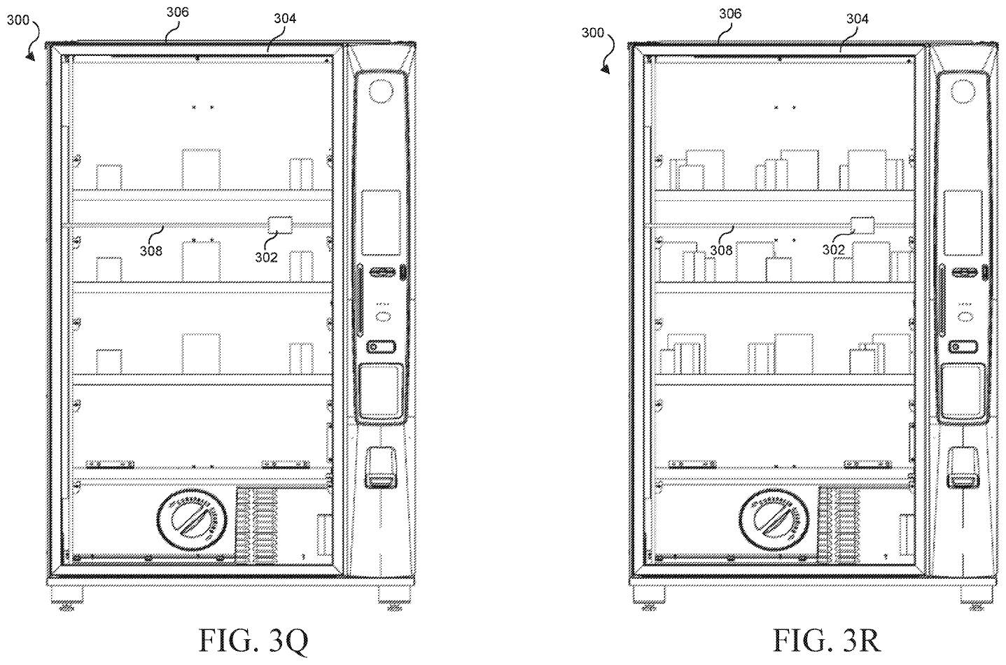

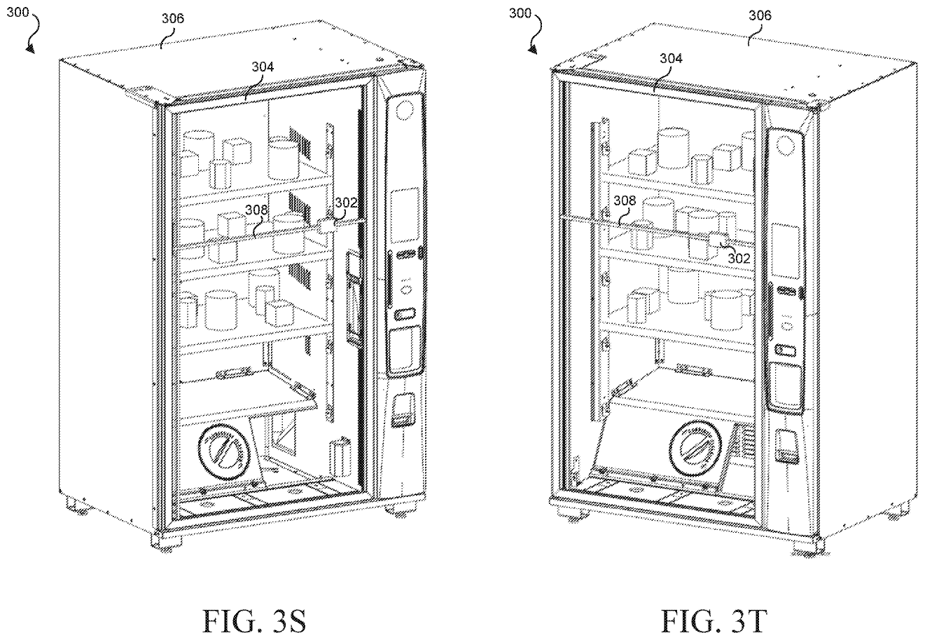

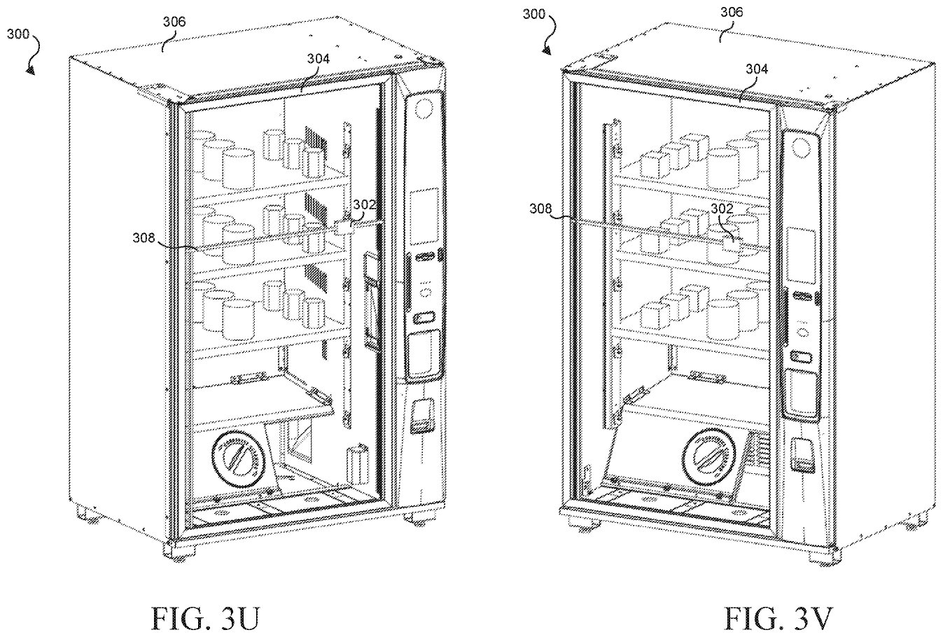

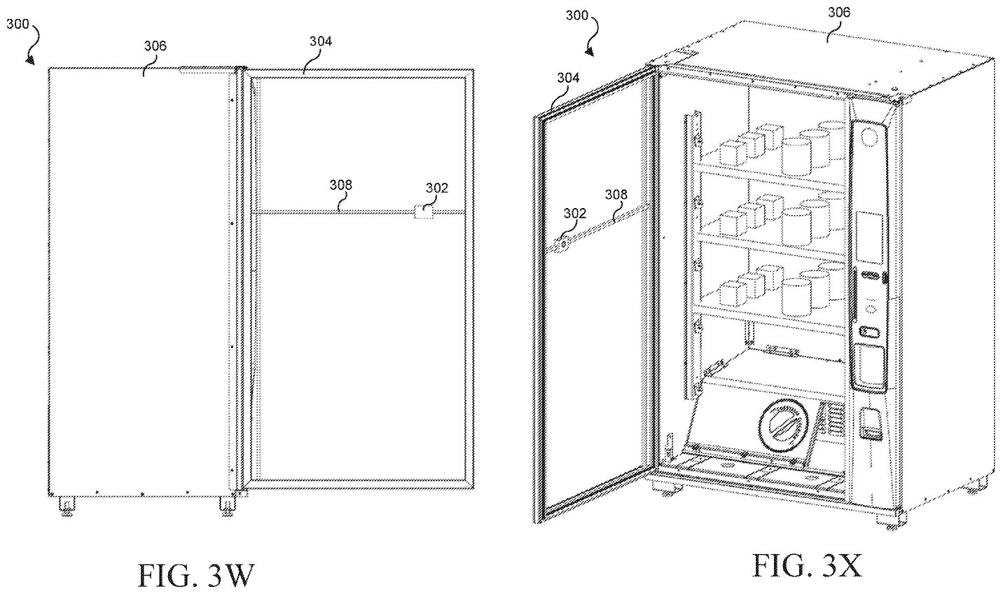

FIGS. 3A-3X illustrate various views of an example smart unattended retail device 300 including a vision system with rectilinear motion according to embodiments of the present disclosure. In various embodiments, the unattended retail device 300 can be an unattended retail device as described in various other embodiments of this disclosure, such as the unattended retail device 102 of FIG. 1 or the unattended retail device 200 of FIG. 2.

FIGS. 3A and 3B illustrate the unattended retail device 300 with a imaging device 302 facing outward from a top center side of a door 304 of a cabinet 306 of the unattended retail device 300. FIGS. 3C and 3D illustrate the unattended retail device 300 with the imaging device 302 facing outward from a top center side of a door 304 with the door 304 open. FIGS. 3E-3J illustrate the unattended retail device 300 with the imaging device 302 facing outward from a bottom left side of the door 304. FIGS. 3K and 3L illustrate the unattended retail device 300 with the imaging device 302 facing outward from a bottom left side of the door 304 with the door 304 open. FIGS. 3M and 3N illustrate the unattended retail device 300 with the imaging device 302 facing inward at a bottom left side of the door 304. FIGS. 30 and 3P illustrate the unattended retail device 300 with the imaging device 302 facing outward from a center right side of the door 304 with the door 304 open. FIG. 3Q illustrates the unattended retail device 300 with the imaging device 302 facing inward at a center right side of the door 304. FIGS. 3R-3T illustrate the unattended retail device 300 with the imaging device 302 facing inward at a center right side of the door 304 with products rearranged by customers. FIGS. 3U and 3V illustrate the unattended retail device 300 with the imaging device 302 facing inward at a center right side of the door 304 with products arranged in a planogram. FIGS. 3W and 3X illustrate the unattended retail device 300 with the imaging device 302 facing inward at a center right side of the door 304 with the door 304 open.

As shown in FIG. 3A, for example, the unattended retail device 300 can be a cooler or refrigeration device that includes in the cabinet 306 a shelving system including a plurality of shelves 310 for holding a plurality of products of various product types. The door 304 can include a window 312 made of glass, plastic, or other transparent material that allows for customers to view the products stored on the shelves 310. The door 304 of the unattended retail device 300 can lock or unlock via an electronic lock, such as electronic lock 106, when a customer decides to make a purchase, allowing the customer to open the door 304 of the cabinet and retrieve one or more products. In some embodiments, the electronic lock engages or disengages a locking mechanism associated with a handle coupled to the door 304. In some embodiments, the electronic lock can engage or disengage a locking mechanism integrated between the door 304 and a portion of the cabinet that holds the door secured against the cabinet.

As also shown in FIG. 3A, for example, the unattended retail device 300 also can include a control panel 314. In various embodiments, the control panel 314 can include various interfaces such as one or more payment interfaces that can include physical payment interfaces such as a card swipe or slot, wireless payment interfaces, or both. For example, in embodiments of this disclosure, a customer mobile device such as a smartphone or other device can communicate with the unattended retail device 300 wirelessly, such as via a BLUETOOTH connection or other wireless connection, to perform transactions such as purchasing products from the unattended retail device 300. The mobile device can include a mobile application configured to communicate with both the unattended retail device 300 to establish customer and machine identifications, and with the cloud server to provide the customer and machine identifications, as well as to facilitate payment for products. In some embodiments, an operator can use a similar mobile device executing an application to similarly communicate with the smart vending machine to, for example, add new products to the unattended retail device 300.

Various funding sources can be used to facilitate payment by a customer for a product stored within the smart vending machine. For example, in various embodiments, the server(s) stores credit, debit, or ePayment information and a pre-authorization that is associated with a user. A pre-authorization for a transaction is made before the unattended retail device 300 is unlocked, and settlement is made once a product has been removed and the door is locked. In some embodiments, an electronic wallet can be associated with each customer account and stored at, or in association with, the cloud server. The aforementioned credit, debit, or ePayment information can be used by a customer to manually add funds to the wallet, or the system can be configured, such as in accordance with customer preferences or settings, to automatically add funds to the wallet, such as if the value of the products removed exceeds the amount stored in the wallet, or if the funds in the wallet fall below a threshold. In some embodiments, a third-party wallet-type system can be used, such as GOOGLE PAY, to fund a transaction from the mobile application on the mobile device, and a transaction success status is sent to the cloud server to trigger unlocking of the cabinet 306, or dispensing of a product in some embodiments. In some embodiments, a paper coupon can be scanned by the mobile application to facilitate payment, or an electronic coupon can be stored in the cloud that can be redeemed for a product.

As illustrated in FIGS. 3A-3X, the smart unattended retail device 300 includes the imaging device 302, which in various embodiments can identify one or more customers positioned in front of the smart unattended retail device 300. The imaging device 302 can be part of a vision system 301 that can include the imaging device movement system 308 and its various components, as well as other components such as the control board and processor 108. The vision system 301 can preauthorize a phone, an application, the control panel 314, etc., for a transaction based on the identified one or more customers. The vision system can identify characteristics of the one or more customers including age, gender, etc. When described as a “customer,” a customer can refer to anyone that passes in front of the cabinet, including potential customers. Therefore, the smart unattended retail device 300 can identify customers that stop and purchase one or more items, customers that stop and do not purchase any items, customers that walk by the smart unattended retail device 300 without stopping, etc. The demographics of the different customers can be identified and sent to a centralized server, such as the server(s) 112, for analysis. The analysis can indicate items in the smart unattended retail device 300, an arrangement of items in the smart unattended retail device 300, a location of the unattended retail device 300, advertisements displayed using the unattended retail device 300, audio output from the unattended retail device 300, etc.

For example, the unattended retail device 300 can identify that a lower than average amount of customers walk by on a daily basis and that the smart unattended retail device 300 could be better utilized in a different location. As another example, the unattended retail device 300 can use the demographics of the customers that do not stop to determine whether different products should be stocked in the cabinet. As another example, the smart unattended retail device 300 can also use the demographics of the customers to control directed advertising on one or more displays. As yet another example, the smart unattended retail device 300 can identify an amount of customers to control a temperature or lighting of the cabinet. For instance, at times where a lower amount of customers that pass the machine can cause an operating temperature to be lowered and a lighting of the cabinet to be reduced.

The imaging device 302 can be used for product auditing. The imaging device 302 can also be used in conjunction with image recognition models or algorithms, such as the machine learning model(s) 118, included in a memory of the unattended retail device 300, in some embodiments. In some embodiments, the product auditing and/or image recognition models or algorithms are stored in a cloud server(s), such as the server(s) 112, with the unattended retail device 300 providing images, using one or more imaging devices 302, to the cloud server(s) for processing and/or auditing. In various embodiments, the server(s) controls the locking/unlocking of the electronic lock as well as receiving product removal reports from the smart vending machine, in addition to other functions. The unattended retail device 300 can communicate with the cloud server via the one or more network interfaces, and the smart vending machine and cloud server can be coupled via a wired or wireless network connection over a network such as a wide area network (WAN) or the Internet.

In various embodiments of this disclosure, the one or more imaging devices 302 can be one or more image capture devices such as a still image capture device or video camera device. In some embodiments, as shown in FIG. 3A, one or more other imaging devices, such as an imaging device 316, can be installed on an exterior portion of the chassis of the unattended retail device 300, and positioned to view an area covering an opening of the door 304. In some embodiments, the one or more other imaging sensors are installed within the cabinet 306, such as two cameras placed diagonally at separate corners of the interior of the cabinet 306. In some embodiments, an operator can use an image capture device, such as a handheld camera and/or a smartphone device, to capture images of products within the smart vending machine, or images of new products to be added to the smart vending machine system. In some embodiments, the system includes two or more image capture devices that capture video of products moving in and/or out of the machine to maintain accurate product inventory information. In some embodiments, image capture devices can be placed in areas where products on shelves are seen, such as placed to view through a window of the cabinet, or when cameras are placed inside the cabinet. In such embodiments, before and after images of products in the cabinet can be captured, that is, before a customer removes products and after a customer removes products.

Thus, at least one first sensor comprising external imaging sensors, such as the imaging device 316, can form a vision based detection system that can track products removed from the cooler and track products placed into the cooler to track available inventory. At least one second sensor comprising at least an imaging device 302 installed on the movable imaging device system 308 can form a vision system that can automatically provide an audit of the products currently in the unattended retail device 300, remotely provide images of the shelves 310 for dispute resolution and hygiene purposes, and view consumer activity in close proximity to the machine. As shown for example in FIG. 30, the at least one imaging device 302 can include an imaging device housing 318 including an image sensor 320. The housing 318 is coupled to the imaging device movement system 308 to allow the imaging device 302 move to a plurality of positions relative to the window 312 and the shelves 310.

For example, when the unattended retail device 300 is idle, a controller, such as a processor or CPU, can initiate an audit to verify the contents of the unattended retail device 300. At least one imaging device 302 of the second sensor system will inspect the shelves 310 and determine the products and their positions. To provide full coverage, the imaging device(s) 302 is mounted in the door 304 and can move using the imaging device movement system 308 in both an X axis and a Y axis. In some embodiments, when parked, the imaging device(s) 302 can view an immediate vicinity within the cabinet 306 via mirrors and lenses, allowing the imaging device(s) 302 to both inspect the shelves 310 and monitor consumer behavior before and after a transaction. In various embodiments, this auditing system using the imaging device(s) 302 can also detect foreign objects placed in the machine and can cause a processor to disable the system until a supervisor has reviewed the object and authorized resumption of transactions. The auditing system can also provide visual information that can be remotely viewed to assist with foreign object detection, planogram adherence, and monitoring of a current state of products within the smart cooler.

In various embodiments of this disclosure, the vision system with rectilinear motion can be, or include as a component, the imaging device movement system 308. The vision system provides for a more accurate means of recording the exact type, position, and count of products on each shelf and also addresses some of the vulnerabilities to vandalism. The smart unattended retail device 300 thus provides a way to assess the inventory by scanning products on each shelf 310 to detect products front to back and side to side, providing a much more accurate accounting of the inventory. The different views of the products are accomplished through the one or more imaging sensors 320 positioned on or within the housing 318 that can look inwards towards the products in the cabinet and outward towards the customers. As shown in FIGS. 3A-3X, the housing 318 can be mounted on a mechanism that travels vertically up and down and/or transversely across the face of the cabinet 306, recording the position of merchandise/products on each shelf front-to-back. The vision system can also provide live video to an operator. The live video can be continuously transmitted, transmitted upon detection of a customer, transmitted based on detecting the door to the smart unattended retail device opening, transmitted based on detected vandalism, etc. The live video can allow for a transaction or act of vandalism to be monitored by an operator in real time or near real time.

As also shown in FIGS. 3A-3X, the imaging device movement system moves the imaging device 302 using an X-Y mechanism. The imaging device 302 can be mounted on the cabinet 306, on an outer portion of the door 304, or within the construction of the door 304 itself, such as between plates of glass or plastic that are part of the door construction, which provide different advantages. Some of the advantages include having access to the camera/mechanism for service, discouraging attempts to obscure the field of view and physical vandalism, etc. The X-Y mechanism can move the image device housing 318 within a plane of the cabinet to view the entire contents of the cabinet 306 or areas external to the cabinet 306 from multiple angles. For example, the X-Y imaging device movement system 308 can move the imaging device 302 between various positions such as the top center side such as shown in FIGS. 3A-3D, the bottom left side such as shown in FIGS. 3E-3N, the center right side such as shown in FIGS. 30-3X, and other positions.

Additionally, in various embodiments, the imaging device movement system 308 is operable to rotate the imaging device 302 such that the imaging device 302 can face outward to view exterior subjects such as customers, such as shown in FIGS. 3A-3L, 30, and 3P, or inward to view interior subject such as products on the shelves 310, such as shown in FIGS. 3M, 3N, and 3Q-3X. In such embodiments, the imaging device 302 rotates about an axis of the vertical or horizontal movement to enhance the field of view, such as by using motorized wheels or rollers within the housing that move against the rail, rod, or cable of the movement system to turn the housing 318. The imaging device 302 can be rotated to face inward for product auditing, recognizing defective products, etc. The imaging device 302 can also be rotated to face outward for customer identification, authorization, age verification, traffic or potential customers identification, etc. An outward facing imaging device 302 can also aid in identifying vandalism to the machine or identify perpetrators of the vandalism. The outward facing imaging device 302 can also identify demographics of customers and potential customers passing by the smart unattended retail device.

The vision system can be used to detect false items or vandalized items placed in the cabinet 306. A false item can be an item that is not included as a sellable product or a product that is not on a planogram, a product that is unidentifiable, etc. In certain embodiments, a false item can be a different size than typically carried in one or more smart unattended retail devices in a smart unattended retail system. For example, a 12-ounce soft drink may not be switched with an 8 ounce soft drink of a same brand. A vandalized item can include items that are opened, items that are otherwise not secured, etc. When a false or vandalized item is identified using the imaging device(s) 302, the cabinet can be locked and a message can be displayed on one or more of the displays of the smart unattended retail device 300. Additionally or alternatively, a message can be transmitted by the unattended retail device 300 to an operator of the smart unattended retail device 300 or by the smart unattended retail system to remove the false or vandalized items and/or clean the cabinet. The display can also indicate to users the status of the machine to not further frustrate a customer that desires to purchase one or more items in the smart unattended retail device 300. A location of the machine can also be sent to the operator to more quickly locate the smart unattended retail device taken offline with a locked cabinet.

The vision system can also be used to identify items in a planogram. A planogram is an arrangement design for products stored in the cabinet 306 and locations of the items. The operator can use the planogram arrangement of the cabinet 306 appropriately for placing products within the cabinet 306. The smart vision system can allow for some deviation from the planogram to maintain sales while an operator is not available or in transit. The deviation from the planogram can be set to accommodate users that replace items in the machine in a different place from where an item was originally found. For instance, a customer may desire an item on a lower shelf at first and later decide to return the item or that the item should remain. In order to maximize a customer experience, a customer may place an item in a different location from the planogram. The vision system can identify the misplaced product while maintaining operations of the smart unattended retail device 300. In some embodiments, the vision system can highlight within one or more captured images a space or an object that is in conflict with the planogram. In addition, the vision system can show conflicted spaces or objects on the screen of the machine. In some embodiments, the vision system can identify new products placed in the cabinet. The new items can include items that the operator is adding to the smart unattended retail device, items that are not normally included in the smart unattended retail device but are able to be added, etc. The vision system can capture a new item for multiple angles for identification and for display. For example, a new item placed in the cabinet can be captured and displayed on one or more of the displays of the smart unattended retail device.

Stationary cameras in the smart unattended retail device can have items obstructed from view based on different placement of items on different shelves of the smart unattended retail devices. Cameras in fixed locations are often mounted in positions so as to create a field of vision across the face of a cabinet/storage space, which allows for the ability to see products removed and placed on the shelves. However, these stationary cameras often cannot see into the depth of the shelf, and thus may not accurately capture the true inventory remaining after a consumer interaction. This could result in disruption of planogram maintenance, inaccurate inventory reporting for replenishment, introduction of foreign products, etc. The X-Y mechanism and moveable camera housing(s) of this disclosure provide for enhancing the audit vision system to identify objects that are obstructed to the audit vision system. Also, defective or opened items may be difficult to identify by the audit vision system. The movement of the X-Y mechanism allows for different views of products that might identify these issues, such as a can or a bag that has been opened but not removed. In some embodiments, the smart unattended retail device 300 includes both stationary cameras and movable cameras as described herein. As shown in FIGS. 3A-3X, the X-Y mechanism provides repeatable vertical and/or horizontal movement in a smooth and controlled way that is accomplished by mounting the imaging device housing 318 on a rail, rod or cable with motility provided through the use of one or more belts or cables driven by a bi-directional motor positionally controlled through software. In some embodiments, the housing 318 may also contact the inner surfaces of the panes defining the inner space of the door 304 to suspend the imaging device 302 within the inner space of the door 304.

In various embodiments, the imaging device housing 318 on the X-Y mechanism can have a default position. For example, the X-Y mechanism can have a default position for the housing 318 relative to the door 304, such as at a top center side, a middle right side, a bottom left side, etc. In certain embodiments, a default position can be based on an optimal location for identifying customers, such as the top center or middle right. In certain embodiments, a default position can be based on a charging location for the imaging device 302, such that the imaging device 302 is near a wireless charging device. In certain embodiments, the charging position and the default position can be different. In some embodiments, the imaging device 302 can be powered through an electrical wire connected to a power source within the unattended retail device 300. In some embodiments, an optimal position for viewing customers may be in a location where wiring, electrical connection, or wireless charging would be difficult to accommodate.

In various embodiments, a current position of the imaging device 302 can be determined based on various parameters. For example, the imaging device 302 can be moved to a particular positions based on parameters such as a charge level of the imaging device 302, a number of the customers identified in front or passing by the cabinet 306, a timing parameter or machine status indicating a product audit should be performed, etc. For example, a low charge level might require that the imaging device 302 return to the charge position between openings of the cabinet. The imaging device 302 may return to the charging position after not identifying a customer or potential customer passing by the smart unattended retail device for a period of time. Alternatively, a high charge level may allow for the imaging device 302 to be position in a default viewing position even when few customers are passing by the smart unattended retail device.

In certain embodiments, the default location of the imaging device 302 could be determined based on a status of the door 304. For example, when the door is closed, the default position may have the camera facing outward at the top center of the cabinet 306, such as shown in FIGS. 3A and 3B. When the door is opened, the imaging device 302 could face inward or the side of the door 304 that would be inward when the door 304 is closed, such as shown in FIGS. 3W and 3X in which the imaging device 302 is located at a middle right side of the door 304, which allows the imaging device 302 to have a side angle of the customer removing or replacing items within the cabinet 306.

In certain embodiments, the X-Y mechanism of the imaging device movement system 308 can include more than one imaging device 302. For example, at least one imaging device 302 can be directed to capture images or videos of the interior of the cabinet 306 and at least one imaging device 302 can be directed to capture images or videos of the outside of the cabinet in front of the smart unattended retail device 300. The multiple imaging devices 302 can be installed on multiple rails, rods, or cables of the imaging device movement system 308 that can each be separately moveable. The inward facing imaging device(s) 302 and the outward facing imaging device(s) 302 can be the same or have different characteristics, including focal lengths, resolution, etc. In some embodiments, the imaging device 302 can have a lens positioned to the front of the cabinet 306 facing to the outside of the cabinet 306, allowing a view into the surrounding environment. In some embodiments, the imaging device 302 includes a proximity sensor or device-to-device beacon to detect movement and recognize the presence of prospective customers.

In some embodiments, the imaging device housing 318 can include one or more light sources to illuminate image captures areas within or outside unattended retail device 300 to improve image quality and accuracy of the images captured. The additional light source(s) can be an LED positioned on the imaging device housing 318 of the X-Y mechanism. The light source on the housing 318 can be used in coordination with the imaging device when capturing products in the cabinet 306 or viewing customers or vandals outside the smart unattended retail device 300. The light source could also be used to notify an operator, for example, when a smart unattended retail device 300 is located in proximity to other smart unattended retail devices or normal unattended retail devices. The LED can also be controlled based on the customer passing by the smart unattended retail device 300. In some embodiments, the LED can emit infrared (IR) illumination that can be used for product identification, customer identification, etc. In some embodiments, the LED can emit ultraviolet (UV) illumination that can be used for product identification, to disinfect selected products, etc. For example, if a customer touches a product and does not purchase the product, the processor of the unattended retail device 300 can trigger an irradiation process in which that product can be irradiated with UV illumination to disinfect the product.

Although FIGS. 3A-3X illustrate one example of a smart unattended retail device 300, various changes may be made to FIGS. 3A-3X. For example, in addition to the variations described above, various components in FIGS. 3A-3X may be combined, further subdivided, replicated, or rearranged according to particular needs. In general, unattended retail devices can come in a wide variety of configurations, and FIGS. 3A-3X do not limit the scope of this disclosure to any particular configuration of an unattended retail device. Also, while FIGS. 3A-3X illustrate one operational environment in which various features disclosed in this patent document can be used, these features could be used in any other suitable system.

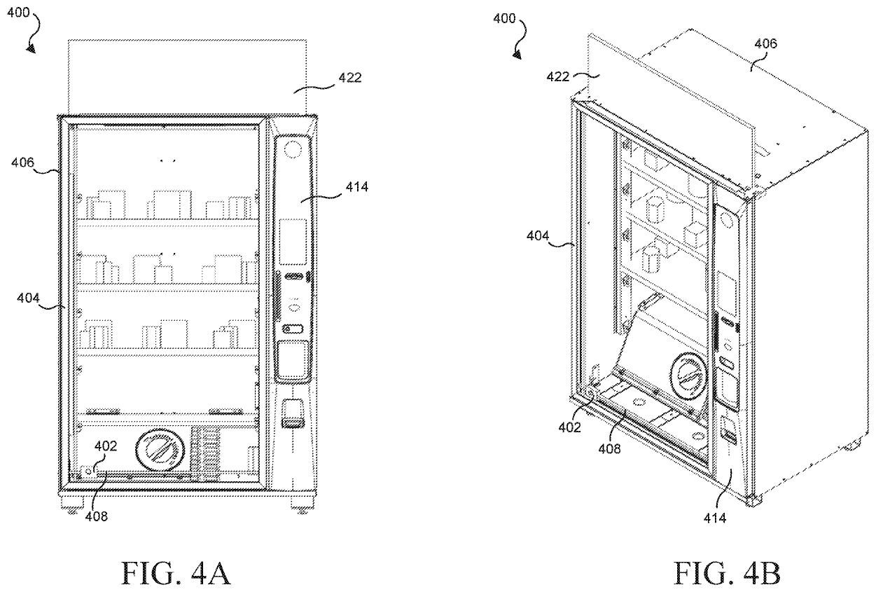

FIGS. 4A and 4B illustrate an example smart unattended retail device 400 including a vision system with rectilinear motion according to embodiments of the present disclosure. In various embodiments, the unattended retail device 400 can be an unattended retail device as described in various other embodiments of this disclosure, such as the unattended retail device 102 of FIG. 1, the unattended retail device 200 of FIG. 2, or the unattended retail device 300 of FIGS. 3A-3X.

The smart unattended retail device 400 can include the same or similar components as the unattended retail device 300 described with respect to FIGS. 3A-3X, such as an imaging device 402, a door 404, a cabinet 406, and an imaging device movement system 408. The smart unattended retail device 400 can also include one or more external displays 422. As shown for example in FIGS. 4A and 4B, an external display 422 is mounted to a top surface of the cabinet 406. The external display 422 can be wiredly or wirelessly connected to a processor and memory of the smart unattended retail device 400. Various content can be shown on the display 422. For example, targeted advertising can be shown to customers in front of the cabinet 406. Paid advertising can also be shown to customers in front of the cabinet 406. Based on the vision system of the smart unattended retail device 400, the advertisement and other displays can be determined based on demographics of customers in front or passing by the smart unattended retail device 400. The external display 422 can also provide transactional information to a customer. The external display 422 can also indicate whether the door 404 to the smart unattended retail device 400 is locked or identify any vandalism that has occurred. The external display 422 can also display an image, video, or live feed captured by the smart vision system.

It will be understood that, while the external display 422 can be located at a top portion of the smart unattended retail device 400 as illustrated in FIGS. 4A and 4B, the external display 422 could be located at another location in other embodiments, such as on a side control panel 414. In some embodiments, the external display 422 can provide active feedback and other information to operators of the smart unattended retail device 400, such as machine learning training instructions. In some embodiments, the external display 422 can be a static display such as a physical image that could be configured to show various information, such as a logo of the owner of the smart unattended retail device 400, a logo of a store in which the smart unattended retail device 400 is located, product information for products in the smart unattended retail device 400, and/or instructions for customers on how to provide payment to purchase products from the smart unattended retail device 400.

Although FIGS. 4A and 4B illustrate one example of a smart unattended retail device 400, various changes may be made to FIGS. 4A and 4B. For example, in addition to the variations described above, various components in FIGS. 4A and 4B may be combined, further subdivided, replicated, or rearranged according to particular needs. In general, unattended retail devices can come in a wide variety of configurations, and FIGS. 4A and 4B do not limit the scope of this disclosure to any particular configuration of an unattended retail device. Also, while FIGS. 4A and 4B illustrate one operational environment in which various features disclosed in this patent document can be used, these features could be used in any other suitable system.

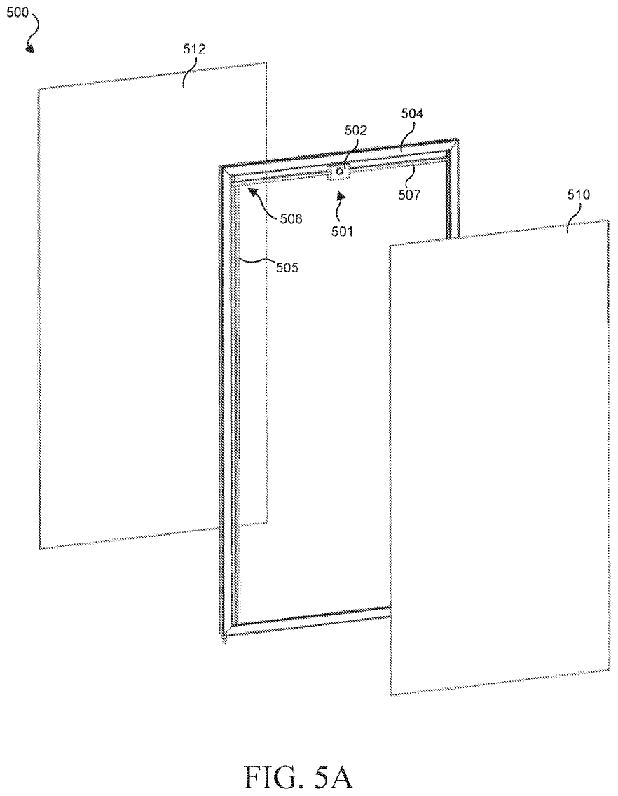

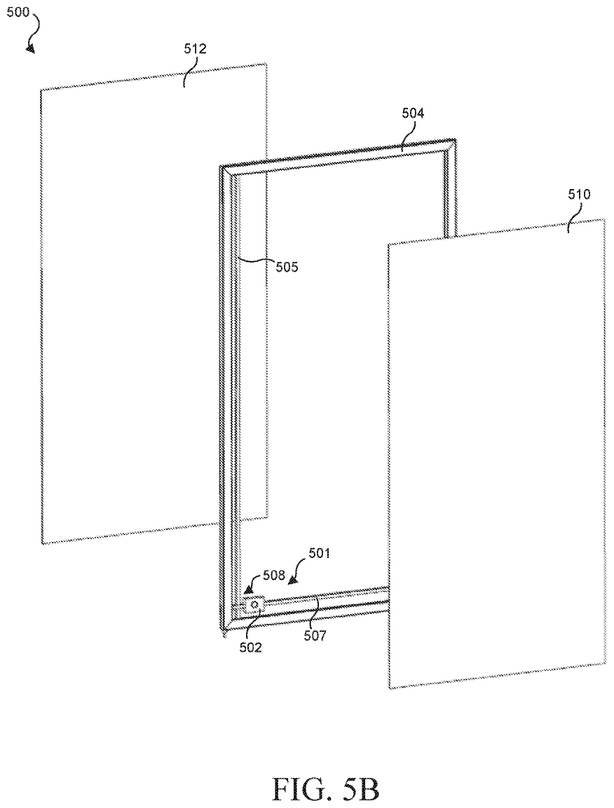

FIGS. 5A and 5B illustrate an example door assembly 500 including a vision system 501 with rectilinear motion within a two pane door according to embodiments of the present disclosure. In various embodiments, the door assembly 500 can be included in an unattended retail device as described in various other embodiments of this disclosure, such as the unattended retail device 102 of FIG. 1, the unattended retail device 200 of FIG. 2, the unattended retail device 300 of FIGS. 3A-3X, or the unattended retail device 400 of FIG. 4.

As described in various embodiments of this disclosure, the vision system 501 includes an imaging device 502, which can be the imaging device 302 or the imaging device 402. The vision system 501 also includes an imaging device movement system 508 that includes at least one rail, rod, or cable on which the imaging device 502 is moveably mounted. For example, the vision system 501 can include a first rail, rod, or cable 505 that extends vertically along a height of a door frame 504, and a second rail, rod, or cable 507 that extends horizontally along a width of the door frame 504. Vertical and/or horizontal movement of the imaging device 502 on the first and/or second rails, rods, or cables 505, 507 can be accomplished in a smooth and controlled way through the use of one or more belts or cables driven by a bi-directional motor (not shown) positionally controlled through software that moves the imaging device 502 vertically along the first rail, rod, or cable 505 and/or horizontally along the second rail, rod, or cable 507.

For example, as shown in FIG. 5A, the imaging device 502 is positioned at a top center location relative to the door frame 504, and, as shown in FIG. 5B, the imaging device 502 can be moved to other locations using the imaging device movement system 508, such as a bottom left location shown in FIG. 5B. It will be understood that the imaging device movement system 508 can allow for the imaging device 502 to move across both the height as well as the width of the area within the door frame 504. It will be understood that, depending on the configuration, size, or dimensions of the unattended retail device in which the door assembly 500 is installed, and/or other needs of the system or operators, the vision system 501 may include just one of the first rail, rod, or cable 505 or the second rail, rod, or cable 507 to provide one of the vertical or horizontal movement.

As shown in FIGS. 5A and 5B, the vision system 501 can be positioned in the door frame 504 between two panes or panels, a first panel 510 and a second panel 512. The panels 510, 512 can be made of a transparent material such as glass or plastic. The first panel 510 can separate the vision system 501 from an outside of the door or cabinet. The second panel 512 can be positioned on the door frame 504 on an opposite side of the vision system 501 to enclose the vision system 501 within a space of the door. The space of the door can be filled with argon or another gas to reduce heat transfer through the transparent material of the door, with the panels 510, 512 containing the gas within the door assembly 500. The vision system 501 can be located within this space to also protect from vandalism or accidental damage, such as to the imaging device 502 or the X-Y movement system 508.

Although FIGS. 5A and 5B illustrate one example of a door assembly 500, various changes may be made to FIGS. 5A and 5B. For example, in addition to the variations described above, various components in FIGS. 5A and 5B may be combined, further subdivided, replicated, or rearranged according to particular needs. In general, door assemblies can come in a wide variety of configurations, and FIGS. 5A and 5B do not limit the scope of this disclosure to any particular configuration of a door assembly. Also, while FIGS. 5A and 5B illustrate one operational environment in which various features disclosed in this patent document can be used, these features could be used in any other suitable system.

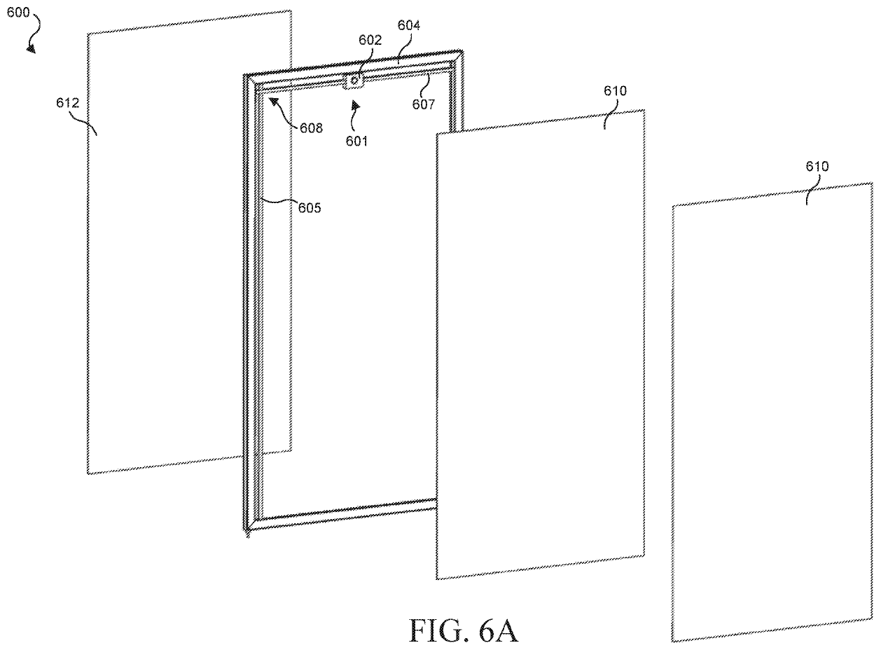

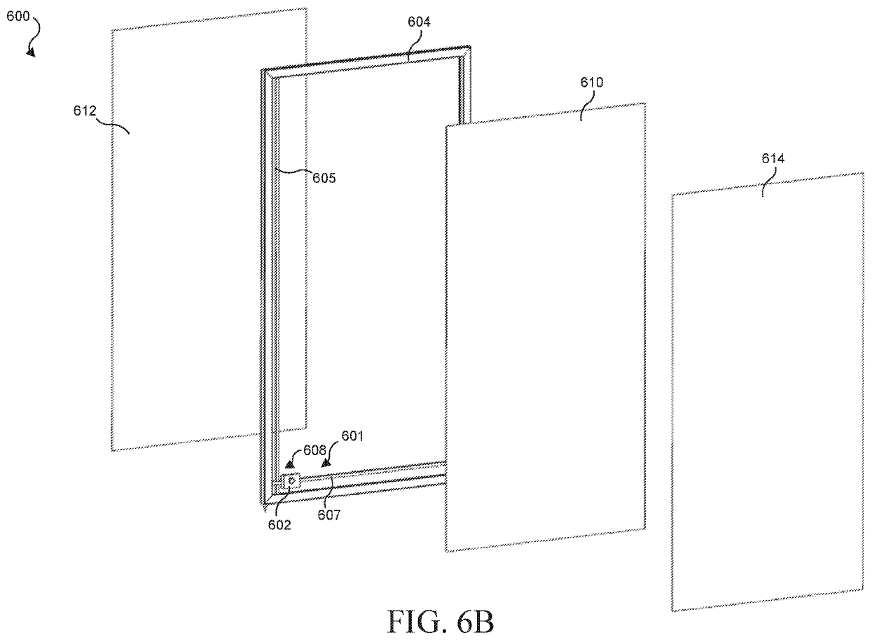

FIGS. 6A and 6B illustrate an example door assembly 600 including a vision system 601 with rectilinear motion within a three pane door according to embodiments of the present disclosure. In various embodiments, the door assembly 600 can be included in an unattended retail device as described in various other embodiments of this disclosure, such as the unattended retail device 102 of FIG. 1, the unattended retail device 200 of FIG. 2, the unattended retail device 300 of FIGS. 3A-3X, or the unattended retail device 400 of FIG. 4.

As described in various embodiments of this disclosure, the vision system 601 includes an imaging device 602, which can be the imaging device 302 or the imaging device 402. The vision system 601 also includes an imaging device movement system 608 that includes at least one rail, rod, or cable on which the imaging device 602 is moveably mounted. For example, the vision system 601 can include a first rail, rod, or cable 605 that extends vertically along a height of a door frame 604, and a second rail, rod, or cable 607 that extends horizontally along a width of the door frame 604. Vertical and/or horizontal movement of the imaging device 602 on the first and/or second rails, rods, or cables 605, 607 can be accomplished in a smooth and controlled way through the use of one or more belts or cables driven by a bi-directional motor (not shown) positionally controlled through software that moves the imaging device 602 vertically along the first rail, rod, or cable 605 and/or horizontally along the second rail, rod, or cable 607.

For example, as shown in FIG. 6A, the imaging device 602 is positioned at a top center location relative to the door frame 604, and, as shown in FIG. 6B, the imaging device 602 can be moved to other locations using the imaging device movement system 608, such as a bottom left location shown in FIG. 6B. It will be understood that the imaging device movement system 608 can allow for the imaging device 602 to move across both the height as well as the width of the area within the door frame 604. It will be understood that, depending on the configuration, size, or dimensions of the unattended retail device in which the door assembly 600 is installed, and/or other needs of the system or operators, the vision system 601 may include just one of the first rail, rod, or cable 605 or the second rail, rod, or cable 607 to provide one of the vertical or horizontal movement.

As shown in FIGS. 6A and 6B, the vision system 601 can be positioned in the door frame 604 within three panes or panels, a first panel 610, a second panel 612, and a third panel 614. The panels 610, 612, 614 can be made of a transparent material such as glass or plastic. The first panel 610 can separate the vision system 601 from an outside of the door or cabinet. The second panel 612 can be positioned on the door frame 604 on an opposite side of the vision system 601 to enclose the vision system 601 within a space of the door between the first panel 610 and the second panel 612. The third panel 614 can be included to contain argon or another gas in a space between the first panel 610 and the third panel 614 separately from the vision system 601. This separation allows for different powering mechanisms of the vision system 601 without being affected by the gas. The gas can also assist with reducing heat transfer through the transparent material of the door. Disposing the vision system 601 behind the panels 610, 614 can also protect the vision system 601 from vandalism or accidental damage, such as to the imaging device 602 or the X-Y movement system 608.

Although FIGS. 6A and 6B illustrate one example of a door assembly 600, various changes may be made to FIGS. 6A and 6B. For example, in addition to the variations described above, various components in FIGS. 6A and 6B may be combined, further subdivided, replicated, or rearranged according to particular needs. In general, door assemblies can come in a wide variety of configurations, and FIGS. 6A and 6B do not limit the scope of this disclosure to any particular configuration of a door assembly. Also, while FIGS. 6A and 6B illustrate one operational environment in which various features disclosed in this patent document can be used, these features could be used in any other suitable system.

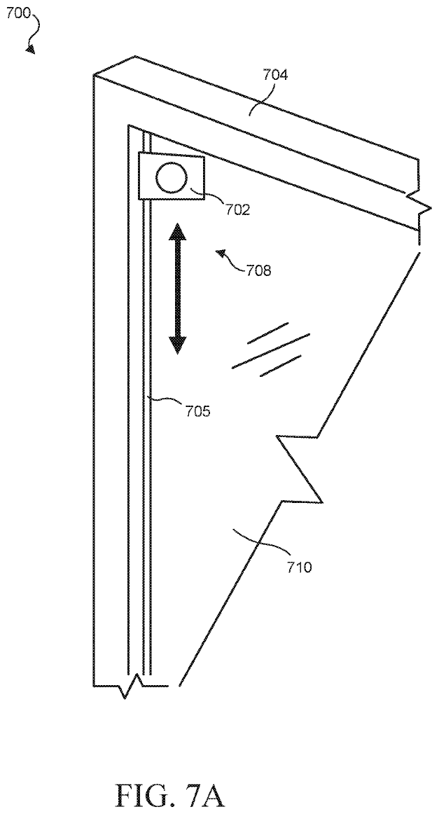

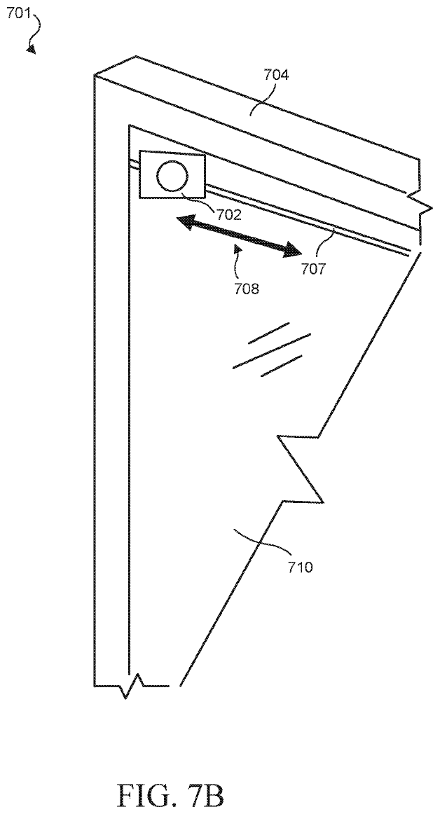

FIGS. 7A and 7B illustrate example vision systems 700 and 701, respectively, with linear motion according to embodiments of the present disclosure. In various embodiments, the vision systems 700 and 701 can be included in an unattended retail device as described in various other embodiments of this disclosure, such as the unattended retail device 102 of FIG. 1, the unattended retail device 200 of FIG. 2, the unattended retail device 300 of FIGS. 3A-3X, or the unattended retail device 400 of FIG. 4. The vision systems 700 and 701 can also be included in a multi-pane door assembly, such as the door assembly 500 of FIGS. 5A and 5B or the door assembly 600 of FIGS. 6A and 6B.

In certain embodiments of this disclosure, a movement system 708 can be structured to move in a single direction, as shown in FIGS. 7A and 7B. For example, when a shelf in a cabinet of an unattended retail device has an ability to rotate, such as a turning table, horizontal movement of the vision system may not be necessary. Thus, as shown in FIG. 7A, the vision system 700 in this example includes a single vertical movement mechanism 705 as part of the movement system 708 installed on a door frame 704 covered by a transparent panel 710, on which an imaging device 702 is mounted to move in a vertical path, without horizontal movement. In such embodiments, the different angles of the products in the cabinet could be captured based on a rotation of the turning table. In some embodiments, depending on the configuration of the unattended retail device, such as shown in the vision system 701 of FIG. 7B, the imaging device 702 could be installed on a single horizontal movement mechanism 707 to allow for only horizontal movement. In various embodiments, the movement mechanisms 705, 707 can include an extension rail, a high pitch screw rod, or a cable, and the imaging device 702 can be moved along the movement mechanism 705, 707 using a belt, a chain, an E-CHAIN, etc.

Although FIGS. 7A and 7B illustrate example vision systems 700 and 701 with linear motion, various changes may be made to FIGS. 7A and 7B. For example, in addition to the variations described above, various components in FIGS. 7A and 7B may be combined, further subdivided, replicated, or rearranged according to particular needs. In general, unattended payment systems and vision systems of this disclosure can come in a wide variety of configurations, and FIGS. 7A and 7B do not limit the scope of this disclosure to any particular configuration of an unattended payment system or vision system. Also, while FIGS. 7A and 7B illustrate operational environments in which various features disclosed in this patent document can be used, these features could be used in any other suitable system.

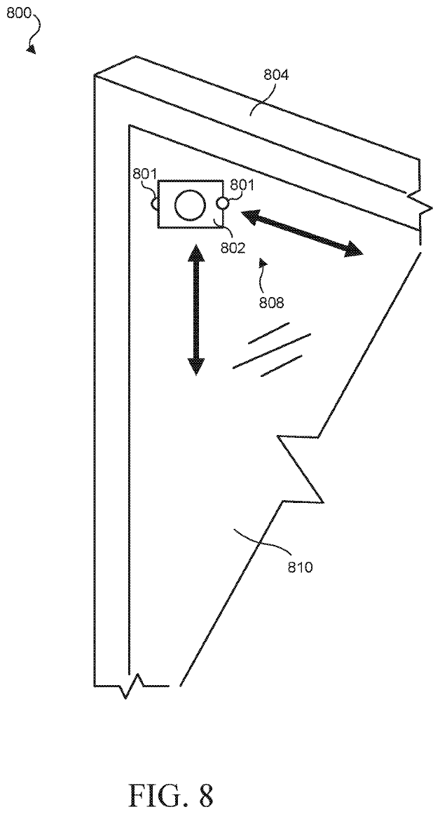

FIG. 8 illustrates an example vision system 800 with one or more rotation devices 801 according to embodiments of the present disclosure. In various embodiments, the vision system 800 can be included in an unattended retail device as described in various other embodiments of this disclosure, such as the unattended retail device 102 of FIG. 1, the unattended retail device 200 of FIG. 2, the unattended retail device 300 of FIGS. 3A-3X, or the unattended retail device 400 of FIG. 4. The vision system 800 can also be included in a multi-pane door assembly, such as the door assembly 500 of FIGS. 5A and 5B or the door assembly 600 of FIGS. 6A and 6B.

In various embodiments, instead of an X-Y movement mechanism, imaging devices of this disclosure can be moved using one or more rotation devices. For example, as shown in FIG. 8, the vision system includes at least one imaging device 802, which can be the imaging device 302, 402, 502, 602, 702 of the various embodiments of this disclosure. The vision system 800 includes a movement system 808 that involves the at least one imaging device 802 being compressed between two panes 810 of a door assembly 804, such as the panes or panels described in FIGS. 5A-6B. In order to move within the interior space defined by the panes 810, the housing of the imaging device 802 includes one or more rotation devices 801 such as one or more balls. Each of the one or more rotation devices 801 contacts one of the panes 810. For example, as shown in FIG. 8, a first rotation device 801 can be included on a front side of the imaging device 802 and a second rotation device 801 can be included on a back side of the imaging device 802, where at least one of the balls can be rotated to move the imaging device 802 in the plane of the door 804.

In some embodiments, more than one imaging device 802 can be used without the imaging devices 802 needing to cross a path of another imaging device 802. In other words, the imaging devices 802 could move freely in the plane of the door 804, avoiding other imaging devices 802. This allows the imaging devices 802 to both operate independently. For example, a first imaging device 802 could be capturing images of customers while a second imaging devices captures images of products in the cabinet. As another example, a first imaging device 802 could be capturing images of products in one area of the cabinet while a second imaging device 802 captures images of products in another area of the cabinet. As another example, a first imaging device 802 could be charging charging while a second imaging device 802 is operating.

Although FIG. 8 illustrates one example of a vision system 800 with one or more rotation devices 801, various changes may be made to FIG. 8. For example, in addition to the variations described above, various components in FIG. 8 may be combined, further subdivided, replicated, or rearranged according to particular needs. For example, in some embodiments, a single rotation device 801 could be mounted through the housing of the imaging device 802, such that the single rotation device 801 rolls against both panes 810 to move the imaging device 802 throughout the interior space of the door 804. Also, although FIG. 8 shows the rotation devices 801 protruding from lateral sides of the imaging device 802, the rotation devices 801 could be located elsewhere, such as interiorly on the front and back surfaces of the housing of the imaging device. In some embodiments, more than two rotation devices 801 can be used, such as one rotation device 801 at each corner of the imaging device. In general, unattended payment systems and vision systems of this disclosure can come in a wide variety of configurations, and FIG. 8 does not limit the scope of this disclosure to any particular configuration of an unattended payment system or vision system. Also, while FIG. 8 illustrate an operational environment in which various features disclosed in this patent document can be used, these features could be used in any other suitable system.

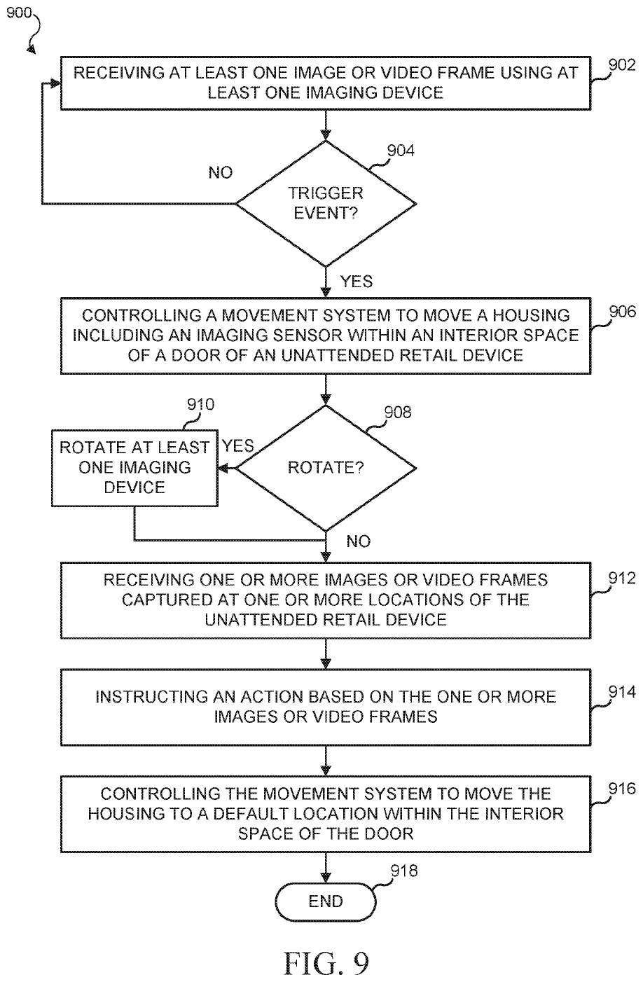

FIG. 9 illustrates an example method 900 for an unattended retail device in accordance with embodiments of this disclosure. For ease of explanation, the method 900 shown in FIG. 9 is described as being performed using a processor, such as the processor 1002, of an unattended retail device, such as the unattended retail devices 102, 200, 300, 400 of this disclosure, and using various components of the unattended retail device. However, the method 900 may be used with any other suitable device(s) and in any other suitable system(s).

At block 902, the processor receives at least one image or video frame using at least one imaging device, such as the imaging devices 302, 402, 502, 602, 702, 802 described in the various embodiments of this disclosure. The images captured at block 902 can be taken while the at least one imaging device is at a default, resting, or starting position, such as while customers are moving in front of the cabinet of the unattended retail device or while customers are interacting with the unattended retail device, such as purchasing products. For example, the process can control the at least one imaging device to track customers and products existing and entering the cabinet while the at least one imaging device is at a vantage point defined by the default position(s). As described in various embodiments of this disclosure, the at least one imaging device can include multiple imaging devices for imaging various subjects simultaneously, such as customers, cabinet shelves, and/or products. In some embodiments, the processor may take no actions at block 902.

At decision block 904, the processor determines whether a trigger event has occurred, the trigger event triggering subsequent movement of the at least one imaging device. For example, the trigger event can include various event detectable by the processor, such as detecting an idle event in which the unattended retail device is idle, such as based on a time of day (e.g., after store hours), determining a predetermined amount of time has passed since detecting a customer presence and/or detecting customer interaction with the unattended retail device, etc. The idle event can be a triggering event to initiate actions that can occur, such as product auditing, during periods where the at least one imaging device does not need to capture images of other activities. In some embodiments, the trigger event can be an event such as a customer opening the door of the cabinet and/or determining that the customer that opened the door is obstructing a view of the at least one imaging device, the processor determining that movement of the at least one imaging device is needed to properly view the products or the customer activity. Other triggering events can be included such as described in various embodiments of this disclosure.

If, at decision block 904, the processor does not detect a trigger event, the method 900 moves back to block 902. If, at decision block 904, the processor detects a trigger event, the method 900 moves back to block 906. At block 906, the processor controls a movement system, such as movement system 308, to move a housing including an imaging sensor of the at least one imaging sensor within an interior space of the door of the unattended retail device, in order to position the at least one imaging device at one or more locations to capture images or video frames of the interior or exterior of the unattended retail device at vantage points provided by the one or more locations. For example, the at least one imaging device can be moved to a vantage point to capture images of products being placed in or taken out of the cabinet, or to capture images of products already stored within the cabinet, or can move to a vantage point to monitor a customer interacting with the payment interfaces of the machine.

In some embodiments as described in this disclosure, controlling the movement system can include moving the housing of the imaging device in one linear direction within the interior space of the door. In some embodiments as described in this disclosure, controlling the movement system can include moving the housing of the imaging device in a first linear direction and in a second linear direction. In some embodiments as described in this disclosure, the movement system includes a rail, rod, or cable on which the housing is moveably mounted. In some embodiments, the door includes at least two panes defining the interior space of the door, and the housing of the imaging device can be compressed in the interior space of the door to contact a surface of each of two panes of the at least two panes with a rotation device included in the movement system, in order to move the imaging device.

At decision block 908, the processor determines whether to rotate the at least one imaging device. For example, the processor can determine to rotate the at least one imaging device on the movement system if the imaging device needs to be turned to face the outside of the cabinet to capture images of customers, or if the imaging device needs to be turned to face the inside of the cabinet to capture images of the interior of the cabinet, such as to capture images of products within the cabinet. If, at decision block 908, the processor determines to not rotate the at least one imaging device, the method moves to block 912. If, at decision block 908, the processor determines to rotate the at least one imaging device, at block 910 the processor controls the movement system to rotate the at least one imaging device. In some embodiments, the unattended retail device can include two or more imaging sensors, with one rotated to face the outside of the cabinet and one rotated to face the inside of the cabinet. The method then moves to block 912.

At block 912, the processor receives one or more images or video frames captured by the at least one imaging sensor at one or more locations within the interior space of the door. At block 914, the processor instructs at least one action based on the received one or more images or video frames, and instructing, using the at least one processor, an action based on the one or more images or video frames. For example, the at least one imaging sensor can be used to identify if operators or customers are placing unauthorized products in the smart cooler, e.g., a foreign product or a product that is not supposed to be there like placing a COKE product in a PEPSI machine, for example. When the processor detects such an event based on the received one or more images, the processor can cause a transmission from the unattended retail device to an operator, or otherwise communicate the issue, such as via a display on an external display of the unattended retail device. The processor can also use the at least one imaging device to validate the correctness of the planogram in the cabinet or guide operators or refilling personnel to arrange products in proper places. The processor can also use the at least one imaging device to detect an unrecognized planogram after a transaction and issue an alert. The processor can also use the at least one imaging device to detect vandalism, such as detecting customers performing vandalism or detecting resulting damage such as visible damage to the door, products, shelves, etc. in the unattended retail device, and issue an alert.

The processor can also use the at least one imaging device to provide anonymous data for building advertisements that can be used for product selection, product recommendations to consumers based on detected consumer demographics, and perform age verification for age restricted products. The processor can also use the at least one imaging device to implement energy savings depending upon consumer traffic. The processor can also use the at least one imaging device to detect bottles that drop and leak in machine and issue an alert. The leaked liquid or paste can dry and make the machine visually unappealing. The processor can also use the at least one imaging device to identify a location of the unattended retail device. At block 916, the processor controls the movement system to move the housing to a default location within the interior space of the door after capturing the one or more images or video frames. The method ends at block 918.

Although FIG. 9 illustrates one example of a method 900 for an unattended retail device, various changes may be made to FIG. 9. For example, while shown as a series of steps, various steps in FIG. 9 could overlap, occur in parallel, occur in a different order, or occur any number of times.

Various changes can be made to embodiments of this disclosure without departing from the scope of this disclosure. In certain embodiments, the vision system provides pictures or images of products that are not in a front row facing an imaging device. For instance, the vision system can take pictures of products from different locations to identify a quantity of products in the unattended retail device. The vision system through its movement can also create a stereoscopic planogram of products in the unattended retail device. This stereoscopic planogram can be used to determine current inventory levels in the unattended retail device.

In certain embodiments, the vision system can take pictures of surroundings of the unattended retail device. These pictures of surroundings can help locate the unattended retail device inside a building. In addition, the vision system can determine what time of the day foot traffic around the unattended retail device is absent. For example, in a school building, foot traffic during holidays and after school hours falls significantly. The unattended retail device can reduce energy consumption by dimming one or more lights, turning off one or more screens, such as the display 422, and lowering the cooling power consumed.

In certain embodiments, the vision system stores pictures of people in front of the unattended retail device if vandalism occurs. The vision system can help identify vandals who attempt to break into the unattended retail device. In addition, the vision system can identify damage done by vandals, such as broken shelves, stolen products, or a broken door. Information provided by the vision system can be used to prepare a repair kit for a service kit.

In certain embodiments, the vision system can be used to identify if there is a product leak. Detection of a product leak using one or more imaging devices can trigger by a processor of the unattended retail device an operation to lock the unattended retail device and initiate and place a service call to clean the product leak in the unattended retail device.

In some embodiments, the vision system is mounted on a radial axis. In these embodiments, the unattended retail device is split into multiple atmospheric zones separated by a seal. A vision system mounted on a radial platform can move along radial distance different angles to cover a sealed or selected area. A different vision system can cover different sealed or selected areas. In some embodiments, the vision system can recommend that an operator change illumination of the unattended retail device by selectively lighting up or turning off lights on some of the shelves. After a product planogram has been modified, to keep the unattended retail device appearing clean and organized, the unattended retail device, using a processor, can selectively turn off lighting to a shelf that has a disorganized product arrangement. In certain embodiments, the unattended retail device can illuminate certain sections of a shelf that are organized and turn off lights to one or more sections of the shelf that is disorganized.

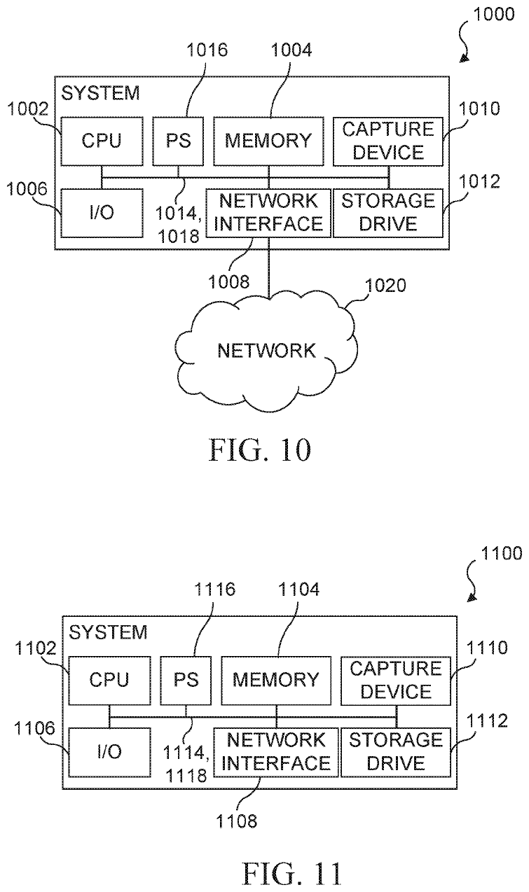

FIG. 10 illustrates an example electronic device 1000 in accordance with various embodiments of this disclosure. The device 1000 can be one example of a portion of the smart unattended retail system, such as the unattended retail devices 102, 200, 300, 400, a server of one or more cloud servers, such as the servers 112, or a mobile device or other electronic device, such as the electronic device 111, or other devices. The device 1000 can include a controller (e.g., a processor/central processing unit (“CPU”)) 1002, a memory unit 1004, and an input/output (“I/O”) device 1006. The device 1000 also includes at least one network interface 1008, or network interface controllers (NICs). The device 1000 can further includes at least one capture device 1010 for capturing media or inputs to the system through an I/O device. In some embodiments, the capture device 1010 can be one or more imaging devices, such as the auditing camera 110, or imaging devices 302, 402, 502, 602, 702. The device 1000 also includes a storage drive 1012 used for storing content such as images, PIN inputs, transaction data, etc. The components 1002, 1004, 1006, 1008, 1010, and 1012 are interconnected by a data transport system (e.g., a bus) 1014. A power supply unit (PSU) 1016 provides power to components of the system 1000 via a power transport system 1018 (shown with data transport system 1014, although the power and data transport systems may be separate). Connections can be wired or wireless, such as the capture device 1010 being wirelessly connected to the processor 1002.

It is understood that the system 1000 may be differently configured and that each of the listed components may actually represent several different components. For example, the CPU 1002 may actually represent a multi-processor or a distributed processing system; the memory unit 1004 may include different levels of cache memory, and main memory; the I/O device 1006 may include monitors, keyboards, touchscreens, and the like; the at least one network interface 1008 may include one or more network cards providing one or more wired and/or wireless connections to a network 1020; and the storage drive 1012 may include hard disks and remote storage locations. Therefore, a wide range of flexibility is anticipated in the configuration of the system 1000, which may range from a single physical platform configured primarily for a single user or autonomous operation to a distributed multi-user platform such as a cloud computing system.

The system 1000 may use any operating system (or multiple operating systems), including various versions of operating systems provided by Microsoft (such as WINDOWS), Apple (such as Mac OS X), UNIX, RTOS, and LINUX, and may include operating systems specifically developed for handheld devices (e.g., iOS, Android, RTOS, Blackberry, and/or Windows Phone), personal computers, servers, and other computing platforms depending on the use of the system 1000. The operating system, as well as other instructions (e.g., for telecommunications and/or other functions provided by the device 1000), may be stored in the memory unit 1004 and executed by the processor 1002. The memory unit 1004 may include instructions for performing some or all of the steps, process, and methods described herein, and can include product information such as product codes and prices, and/or the product recognition models or algorithms in the various embodiments of this disclosure.

The network 1020 may be a single network or may represent multiple networks, including networks of different types, whether wireless or wired. For example, the device 1000 may be coupled to external devices via a network that includes a cellular link coupled to a data packet network, or may be coupled via a data packet link such as a wide local area network (WLAN) coupled to a data packet network or a Public Switched Telephone Network (PSTN). Accordingly, many different network types and configurations may be used to couple the device 1000 with external devices.

FIG. 11 illustrates an example electronic device 1100 in accordance with various embodiments of this disclosure. The device 1100 can be one example of a portion of the smart unattended retail system, such as the unattended retail devices 102, 200, 300, 400, a server of one or more cloud servers, such as the servers 112, or a mobile device or other electronic device, such as the electronic device 111, or other devices. The device 1100 can include a controller (e.g., a processor/central processing unit (“CPU”)) 1102, a memory unit 1104, and an input/output (“I/O”) device 1106. The device 1100 also includes at least one network interface 1108, or network interface controllers (NICs). The device 1100 can further includes at least one capture device 1110 for capturing media or inputs to the system through an I/O device. In some embodiments, the capture device 1110 can be one or more imaging devices, such as the auditing camera 110, or imaging devices 302, 402, 502, 602, 702. The device 1100 also includes a storage drive 1112 used for storing content such as images, PIN inputs, transaction data, etc. The components 1102, 1104, 1106, 1108, 1110, and 1112 are interconnected by a data transport system (e.g., a bus) 1114. A power supply unit (PSU) 1116 provides power to components of the system 1100 via a power transport system 1118 (shown with data transport system 1114, although the power and data transport systems may be separate). Connections can be wired or wireless, such as the capture device 1110 being wirelessly connected to the processor 1102.

It is understood that the system 1100 may be differently configured and that each of the listed components may actually represent several different components. For example, the CPU 1102 may actually represent a multi-processor or a distributed processing system; the memory unit 1104 may include different levels of cache memory, and main memory; the I/O device 1106 may include monitors, keyboards, touchscreens, and the like; and the storage drive 1112 may include hard disks and remote storage locations. Therefore, a wide range of flexibility is anticipated in the configuration of the system 1100. In some embodiments, the device 1100 is not connected to a network via the network interface 1108, such as if the device 1100 is an unattended retail device operating locally without communicating with a central remote system such as a server system. In such embodiments, the network interface 1108 may communicate with local devices such as using near field communications to perform transactions with local user or customer mobile devices.

The system 1100 may use any operating system (or multiple operating systems), including various versions of operating systems provided by Microsoft (such as WINDOWS), Apple (such as Mac OS X), UNIX, RTOS, and LINUX, and may include operating systems specifically developed for handheld devices (e.g., iOS, Android, RTOS, Blackberry, and/or Windows Phone), personal computers, servers, and other computing platforms depending on the use of the system 1100. The operating system, as well as other instructions (e.g., for telecommunications and/or other functions provided by the device 1100), may be stored in the memory unit 1104 and executed by the processor 1102. The memory unit 1104 may include instructions for performing some or all of the steps, process, and methods described herein, and can include product information such as product codes and prices, and/or the product recognition models or algorithms in the various embodiments of this disclosure.

In one example embodiment, a smart unattended retail device includes a cabinet, an auditing camera system, a door, one or more external displays, and a vision system. The cabinet is configured to store items. The auditing camera system is mounted in the cabinet and configured to determine items placed in or removed from the cabinet. The door is configured to open or close an area inside the cabinet and to lock or unlock the cabinet, where the door comprises at least two panes defining an interior space. The one or more external displays are configured to display information. The vision system is positioned within the interior space of the door and includes a camera housing, an X-Y mechanism, and at least one processor. The camera housing includes a camera sensor configured to capture image or video frames. The X-Y mechanism is coupled to the door and the camera housing and is configured to move the camera housing within the space of the door. The processor is operably coupled to the camera housing and the X-Y mechanism. The at least one processor is configured to control the X-Y mechanism to move the camera housing within the space to capture items inserted or removed from the cabinet. The at least one processor is also configured to control the X-Y mechanism to move the camera housing to a default location after capturing the items inserted or removed from the cabinet. The at least one processor is further configured to control the camera housing to rotate the camera sensor towards an inside of the cabinet for capturing the items inserted or removed from the cabinet. The at least one processor is additionally configured to control the camera housing to rotate the camera sensor toward an outside of the cabinet for identifying a customer when at the default location.

In another example embodiment, a smart unattended retail device includes a cabinet, an auditing camera system, a door, one or more external displays, and a vision system. The cabinet is configured to store items and includes rotating shelves. The auditing camera system is mounted in the cabinet and configured to determine items placed in or removed from the cabinet. The door is configured to open or close an area inside the cabinet and to lock or unlock the cabinet, where the door comprises at least two panes defining an interior space. The one or more external displays are configured to display information. The vision system is positioned within the interior space of the door and includes a camera housing, a linear mechanism, and at least one processor. The camera housing includes a camera sensor configured to capture image or video frames. The linear mechanism is coupled to the door and the camera housing and is configured to move the camera housing within the space of the door. The processor is operably coupled to the camera housing and the linear mechanism. The at least one processor is configured to control the linear mechanism to move the camera housing within the space to capture items inserted or removed from the cabinet, where the rotating shelf is rotated to capture the items inserted or removed from the cabinet. The at least one processor is also configured to control the linear mechanism to move the camera housing to a default location after capturing the items inserted or removed from the cabinet. The at least one processor is further configured to control the camera housing to rotate the camera sensor towards an inside of the cabinet for capturing the items inserted or removed from the cabinet. The at least one processor is additionally configured to control the camera housing to rotate the camera sensor toward an outside of the cabinet for identifying a customer when at the default location.

In another example embodiment, a smart unattended retail device includes a cabinet, an auditing camera system, a door, one or more external displays, and a vision system. The cabinet is configured to store items. The auditing camera system is mounted in the cabinet and configured to determine items placed in or removed from the cabinet. The door is configured to open or close an area inside the cabinet and to lock or unlock the cabinet, where the door comprises at least two panes defining an interior space. The one or more external displays are configured to display information. The vision system is positioned within the interior space of the door and includes a one or more camera housings. The one or more camera housings each include a rotating device, a camera sensor, and at least one processor. The rotating device rotation device is configured to move a camera housing by rotating against one or the two panes of the door. The camera sensor is configured to capture image or video frames. The processor is operably coupled to the camera housing and the rotation device. The at least one processor is configured to control the rotation device to move the camera housing within the space to capture items inserted or removed from the cabinet. The at least one processor is also configured to control the rotating device to move the camera housing to a default location after capturing the items inserted or removed from the cabinet. The at least one processor is further configured to control the camera housing to rotate the camera sensor towards an inside of the cabinet for capturing the items inserted or removed from the cabinet. The at least one processor is additionally configured to control the camera housing to rotate the camera sensor toward an outside of the cabinet for identifying a customer when at the default location.

In another example embodiment, a smart unattended retail device includes a cabinet, a door, a vision system, and at least one processor. The cabinet is configured to store items. The door is configured to open or close an area inside the cabinet. The vision system is positioned within the interior space of the door. The vision system includes a camera housing and a mechanism. The camera housing including a camera sensor configured to capture image or video frames. The mechanism is configured to move the camera housing within the space of the door. The at least one processor is operably coupled to the camera housing the mechanism. The at least one processor is configured to control the mechanism to move the camera housing within the space to capture items inserted or removed from the cabinet. The at least one processor is also configured to control the mechanism to move the camera housing to a default location after capturing the items inserted or removed from the cabinet.

In another example embodiment, an unattended retail device comprises a cabinet for storing items, a door configured to open or close an area inside the cabinet, and a vision system positioned within an interior space of the door, the vision system including a movement system coupled to the door, a housing moveably mounted to the movement system, the housing including an imaging sensor configured to capture images or video frames, and at least one processor operably coupled to the imaging sensor and the movement system, wherein the at least one processor is configured to control the movement system to move the housing within the interior space of the door, receive one or more images or video frames captured by the imaging sensor at one or more locations within the interior space of the door, and instruct an action based on the one or more images or video frames.

In one or more of the above examples, the movement system is operable to move the housing in one linear direction within the interior space of the door.

In one or more of the above examples, the movement system is operable to move the housing in a first linear direction and in a second linear direction.

In one or more of the above examples, the movement system includes a rail, rod, or cable on which the housing is moveably mounted.

In one or more of the above examples, the at least one processor is further configured to control the movement system to move the housing to a default location within the interior space of the door after capturing the one or more images or video frames.

In one or more of the above examples, the one or more images or video frames include one or more of at least one image or at least one video frame showing items inserted or removed from the cabinet, and at least one image or at least one video frame showing at least one customer.

In one or more of the above examples, the at least one processor is further configured to control the movement system to rotate the housing to move the imaging sensor towards the area inside the cabinet to capture the at least one image or the at least one video frame showing the items inserted or removed from the cabinet, and control the movement system to rotate the housing to move the imaging sensor towards an area outside the cabinet to capture the at least one image or the at least one video frame showing the at least one customer.

In one or more of the above examples, the door includes at least two panes defining the interior space of the door.

In one or more of the above examples, the housing is compressed in the interior space of the door to contact a surface of each of two panes of the at least two panes, and wherein the housing includes a rotation device configured to move the housing by rotating against at least one of the two panes of the door.

In one or more of the above examples, the unattended retail device further comprises one or more external displays configured to display information.

In another example embodiment, a method comprises controlling, using at least one processor, a movement system to move a housing including an imaging sensor within an interior space of a door of an unattended retail device, wherein the unattended retail device includes a cabinet for storing items, wherein the door opens or closes an area inside the cabinet, and a vision system positioned within the interior space of the door, wherein the vision system includes the movement system and the housing, receiving, using the at least one processor, one or more images or video frames captured by the imaging sensor at one or more locations within the interior space of the door, and instructing, using the at least one processor, an action based on the one or more images or video frames.

In one or more of the above examples, controlling the movement system to move the housing includes moving the housing in one linear direction within the interior space of the door.

In one or more of the above examples, controlling the movement system to move the housing includes moving the housing in a first linear direction and in a second linear direction.

In one or more of the above examples, the movement system includes a rail, rod, or cable on which the housing is moveably mounted.

In one or more of the above examples, the method further comprises controlling, using the at least one processor, the movement system to move the housing to a default location within the interior space of the door after capturing the one or more images or video frames.

In one or more of the above examples, the one or more images or video frames include one or more of at least one image or at least one video frame showing items inserted or removed from the cabinet, and at least one image or at least one video frame showing at least one customer.

In one or more of the above examples, the method further comprises controlling, using the at least one processor, the movement system to rotate the housing to move the imaging sensor towards the area inside the cabinet to capture the at least one image or the at least one video frame showing the items inserted or removed from the cabinet, and controlling, using the at least one processor, the movement system to rotate the housing to move the imaging sensor towards an area outside the cabinet to capture the at least one image or the at least one video frame showing the at least one customer.

In one or more of the above examples, the door includes at least two panes defining the interior space of the door.

In one or more of the above examples, the housing is compressed in the interior space of the door to contact a surface of each of two panes of the at least two panes with a rotation device included in the movement system, and the method further comprises controlling, using the at least one processor, the rotation device to move the housing by rotating against at least one of the two panes of the door.

In one or more of the above examples, the method further comprises displaying, using the at least one processor, information on one or more external displays included in the unattended retail device.

The description in the present application should not be read as implying that any particular element, step, or function is an essential or critical element that must be included in the claim scope. The scope of patented subject matter is defined only by the allowed claims. Moreover, none of the claims invokes 35 U.S.C. § 112 (f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” or “controller” within a claim is understood and intended to refer to structures known to those skilled in the relevant art, as further modified or enhanced by the features of the claims themselves, and is not intended to invoke 35 U.S.C. § 112 (f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

1. An unattended retail device comprising:
a cabinet for storing items;
a door configured to open or close an area inside the cabinet; and
a vision system positioned within an interior space of the door, the vision system including:
a movement system coupled to the door;
a housing moveably mounted to the movement system, the housing including an imaging sensor configured to capture images or video frames; and
at least one processor operably coupled to the imaging sensor and the movement system, wherein the at least one processor is configured to:
control the movement system to move the housing within the interior space of the door;
receive one or more images or video frames captured by the imaging sensor at one or more locations within the interior space of the door; and
instruct an action based on the one or more images or video frames.

2. The unattended retail device of claim 1, wherein the movement system is operable to move the housing in one linear direction within the interior space of the door.

3. The unattended retail device of claim 1, wherein the movement system is operable to move the housing in a first linear direction and in a second linear direction.

4. The unattended retail device of claim 1, wherein the movement system includes a rail, rod, or cable on which the housing is moveably mounted.

5. The unattended retail device of claim 1, wherein the at least one processor is further configured to control the movement system to move the housing to a default location within the interior space of the door after capturing the one or more images or video frames.

6. The unattended retail device of claim 1, wherein the one or more images or video frames include one or more of:
at least one image or at least one video frame showing items inserted or removed from the cabinet; and
at least one image or at least one video frame showing at least one customer.

7. The unattended retail device of claim 6, wherein the at least one processor is further configured to:
control the movement system to rotate the housing to move the imaging sensor towards the area inside the cabinet to capture the at least one image or the at least one video frame showing the items inserted or removed from the cabinet; and
control the movement system to rotate the housing to move the imaging sensor towards an area outside the cabinet to capture the at least one image or the at least one video frame showing the at least one customer.

8. The unattended retail device of claim 1, wherein the door includes at least two panes defining the interior space of the door.

9. The unattended retail device of claim 8, wherein the housing is compressed in the interior space of the door to contact a surface of each of two panes of the at least two panes, and
wherein the housing includes a rotation device configured to move the housing by rotating against at least one of the two panes of the door.

10. The unattended retail device of claim 1, further comprising one or more external displays configured to display information.

11. A method comprising:
controlling, using at least one processor, a movement system to move a housing including an imaging sensor within an interior space of a door of an unattended retail device, wherein the unattended retail device includes:
a cabinet for storing items, wherein the door opens or closes an area inside the cabinet; and
a vision system positioned within the interior space of the door, wherein the vision system includes the movement system and the housing;
receiving, using the at least one processor, one or more images or video frames captured by the imaging sensor at one or more locations within the interior space of the door; and
instructing, using the at least one processor, an action based on the one or more images or video frames.

12. The method of claim 11, wherein controlling the movement system to move the housing includes moving the housing in one linear direction within the interior space of the door.

13. The method of claim 11, wherein controlling the movement system to move the housing includes moving the housing in a first linear direction and in a second linear direction.

14. The method of claim 11, wherein the movement system includes a rail, rod, or cable on which the housing is moveably mounted.

15. The method of claim 11, further comprising controlling, using the at least one processor, the movement system to move the housing to a default location within the interior space of the door after capturing the one or more images or video frames.

16. The method of claim 11, wherein the one or more images or video frames include one or more of:
at least one image or at least one video frame showing items inserted or removed from the cabinet; and
at least one image or at least one video frame showing at least one customer.

17. The method of claim 16, further comprising:
controlling, using the at least one processor, the movement system to rotate the housing to move the imaging sensor towards the area inside the cabinet to capture the at least one image or the at least one video frame showing the items inserted or removed from the cabinet; and
controlling, using the at least one processor, the movement system to rotate the housing to move the imaging sensor towards an area outside the cabinet to capture the at least one image or the at least one video frame showing the at least one customer.

18. The method of claim 11, wherein the door includes at least two panes defining the interior space of the door.

19. The method of claim 18, wherein the housing is compressed in the interior space of the door to contact a surface of each of two panes of the at least two panes with a rotation device included in the movement system,
the method further comprising controlling, using the at least one processor, the rotation device to move the housing by rotating against at least one of the two panes of the door.

20. The method of claim 11, further comprising displaying, using the at least one processor, information on one or more external displays included in the unattended retail device.
